(19) United States
(12) Patent Application Publication
(10) Pub. No.: US 2024/0001477 A1
(43) Pub. Date: Jan. 4, 2024

(54) AN ELECTRIC PORTABLE FRICTION WELDING SYSTEM AND ENHANCED METHOD OF OPERATION

(71) Applicant: FUSEMATIC CORPORATION, Lake Mary, FL (US)

(72) Inventors: John M. GRIFFIN, Daytona Beach, FL (US); Ladd BORNE, Vero Beach, FL (US); Ozkan ERDEM, Oviedo, FL (US); G. Subrahmanya VRK RAO, Jaladampet (IN); Farrell Anthony SMALL,, Sanford, FL (US); Mark Andrew SMITH, Houston, TX (US); Reeder WARD, Melbourne, FL (US)

(73) Assignee: FUSEMATIC CORPORATION, Lake Mary, FL (US)

(21) Appl. No.: 18/267,738

(22) PCT Filed: Dec. 15, 2021
(86) PCT No.: PCT/US2021/063584

§ 371 Date: Jun. 15, 2023

Related U.S. Application Data
(60) Provisional application No. 63/126,507, filed on Dec. 16, 2020.

(51) Int. Cl. B23K 20/12

(52) U.S. Cl. CPC B23K 20/121; B23K 20/1285; B23K 20/1295

(57) ABSTRACT

An automated electric portable friction welding system is disclosed for friction welding a fixture onto a substrate, the welding system having a linear actuator received to produce a defined stroke within a tool housing and a rotary motor engaged to said linear actuator to slide therewith. A control module controls welding operations as a function of encoded instructions and the sensor data from the linear actuator and the rotary motor, whereby the control module affords both active control of the linear actuator and rotary motor, individually to performance parameter instructions, and in coordination through phases of the weld process in response to linear actuator operation sensors and motor operation sensors. Another feature of some embodiments of the present invention is a portable friction welding network and a method for supporting portable friction welding on the cloud.

### RELATED APPLICATION

This application claims the benefits of the filing date of U.S. provisional application Ser. No. 63/126,507, filed by Griffin et al on Dec. 16, 2020 for An Electric Portable Friction Welding System and Enhanced Method of Operation.

### BACKGROUND OF THE INVENTION

The present invention relates to a system, method and components for joining a workpiece to a substrate, and more particularly, to an electric portable or modular friction welding system, its components, and enhanced methods of operation and application.

The present invention supports installation, fabrication and repair operations relying on the installation of fastening elements to a substrate. Such engineered fastening elements (also called workpieces, fittings or fixtures) include, for example, externally threaded studs, internally threaded bosses, bolts and other fittings. There are a number of drawbacks to installing such fixtures through conventional mechanical means. For instance, drilling and tapping takes time, and in many cases it is not possible to drill through a substrate and aligning pre-drilled holes may cause problems. And legacy/conventional welding applications use exposed flame, arc or electrical discharge which create an ignition hazard and may not be practical in areas where combustible gases are present due to the inherent danger of fire or explosion. In addition, the heat generated through such processes may lead to a loss of structural integrity in the bond or adjacent material and may compromise coatings and liners on both the face and back sides of the substrate. Further, material compatibility is another area of concern, e.g., in materials that are difficult themselves or in material combinations that are problematic. While some of these challenges can be tackled on occasion by those of highly specialized skill, much of this remains a difficult area frequently subject to inconsistent and unsatisfactory results at the hands of the common skill levels readily available in the general welding trade applying conventional tools and methods.

Portable friction welding has proven potential for addressing these challenges and providing efficient, consistent, high quality welds installing fixtures to a substrate. Broadly, friction welding is a process for joining materials using a combination of pressure and movement to create friction at the interface of a fixture to be installed and a substrate. Friction induces very localized heating from rotating a fixture held against a substrate to which it is being joined. After the material at this intersection has plasticized, rotation stops and forging force holds the fixture against the substrate until the localized plasticized material solidifies and the weld is complete.

Despite great potential, various challenges have limited the widespread adoption across industry. First, power requirements in high pressure pneumatic and/or hydraulics was inhibiting, though substantially alleviated with the development of all pneumatic portable friction welding tools capable of operating at pressures commonly available in a number of industrial settings. See U.S. Pat. No. 5,699,952, issued Dec. 23, 1997, for an Automated Fusion Bonding Apparatus. Further, the success of these tools was limited by excessive reliance on highly specialized skilled labor and improvements in automating the use of portable friction welding systems was required to bring the capability for efficient, consistent, high-quality welding to tradesmen requiring less, more modest, specialized training over that which defines ordinary skill in the welding arts. See the application of Fix et al, for An Improved Automated Portable Friction Welding System and Method of Operation, international application number PCT/US2020/019483, with an international filing date of Feb. 24, 2020, and now published as WO2020/176406. The specification of PCT/US2020/019483 and publication WO2020/176406 are hereby incorporated by reference.

Solving these issues has brought a robust capability to many applications. However, yet broader adoption to other applications would be better served by a new generation of portable friction welding systems characterized by a modular, application agnostic, portable friction welding tools suitable for deployment in the field or other application where portability allows the welding tool to be brought to the substrate. This would facilitate easy installation into application specific hardware for delivery and operations, e.g., host vehicles such as remotely operated vehicles (ROVs) for terrestrial and underwater applications, autonomous vehicles for terrestrial application, underwater vehicles (AUVs), unmanned aerial vehicles (UAVs or drones), or vehicles for deployment in space, as well as other robotic applications or the like. Further, the convenience of using electricity, the flexibility of greater programmability, and the incorporation of cutting-edge dynamic control and optimization adaptable to the needs of any given application can further enhance smart embodiments of this next generation portable friction welding system.

Therefore, there remains a substantial need for an improved portable welding system, tool and method to more broadly and successfully bring the full benefits of portable friction stud welding to industry.

### BRIEF SUMMARY OF THE INVENTION

To achieve these and other advantages in accordance with the purposes of the present invention, as embodied and broadly described herein, the present invention relates, in part, to an automated electric portable friction welding system for friction welding a fixture onto a substrate. More specifically, the present invention relates to an automated portable friction welding system for friction welding a fixture onto a substrate at an interface between the fixture and the substrate using an electric power system, said system comprising a portable friction welding tool operably connectable to the electric power system and comprising a tool housing; a linear actuator received in an axially slidable relation to produce a defined stroke within the tool housing; a rotary motor disposed in the tool housing and engaged to said linear actuator to slide therewith; a collet configured to receive the fixture; and a control system. The control system comprises one or more motor operation sensor(s); and a control module. The control module comprises a welder controller with inputs from the motor operation sensor(s) and the linear actuator operational sensors(s) and with outputs connected to the linear actuator and the rotary motor; processing hardware capable of receiving and storing welding design models in the form of encoded instructions and receiving input from the motor operation sensor(s) and the linear actuator operation sensor(s) to control welding operations as a function of the sensor input and encoded instructions of a selected welding design model whereby the control module affords both active control of the linear actuator and rotary motor, individually, to performance parameter instructions specified in the welding sign model, and in coordination through phases of the weld process in response to linear actuator operation sensors and motor operation sensors.

Another feature of some embodiments of the present invention is a portable friction welding network for a fleet of portable friction welding tools, said network having a plurality of operator networks, each operator network employing one or more portable friction welding tools within the fleet and an external production system on a remote server. The external production system has a suite of external production system welder application software, a welder device API through which the external production system is connectable to the fleet of portable friction welding tools for loading the welder application software of general-purpose instructions onto the fleet, an external production system welder process instructions engine which serves as a library of friction job specific welding recipes, and an external production system security API through which each of the operator networks can download an applicable welding recipe for a specific job.

Yet other embodiments for practicing a portable friction welding operation addresses a method for supporting portable friction welding operations, comprising: engaging a fleet of portable friction welding tools; establishing a plurality of operator networks; and creating an external production system on a remote server, the external production system having an external production system welder device API, an external production system suite of welder application software, an external production system welder process instructions engine containing a library of job specific welding recipes; and an external production system security API. An internal production system is created on the remote server with an internal production system suite of welder application software, an internal production system welder process instructions engine containing a library of job specific welding recipes, and an internal production system security API. A vetting process is established connecting the external production system and the internal production system. The external production system welder application software is downloaded onto the fleet of portable friction welding tools and a job specific weld recipe of weld parameters suitable of conditions that are thought to characterize a given job is downloaded onto the portable friction welding tool of the operator network a from a library in the external production system welder process instructions engine. Data from job histories are periodically loaded to the external production system and the data is analyzed for broader applicability in a vetting process and communicating the data with potential to the internal production system. Developments within the internal production software is analyzed for effectiveness and applicability and bringing desired developments into the external production system where it will be available to operator networks and to the fleet of portable friction welders.

And another embodiment addresses a method for friction stud welding in the field, said method comprising deploying a friction welding tool having a control module, a rotary motor, a forging force actuator and an array of operational sensors monitoring a predetermined set of variables regarding the operation of the motor and the forging force actuator. A well plan defined by operational values in the predetermined set of variables to a combination of stud size, stud material, substrate material, and environmental conditions is matched and the weld plan is uploaded to the control module. A friction stud welding cycle can then be conducted and moderated through the control module using the weld plan and feedback from the array of operational sensors.

Additional features and advantages of the present invention will be set forth, in part, in the description that follows and, in part, will be apparent upon study of the description or can be learned by practice of the invention. The features and other advantages of the present invention will be realized by means of the elements and combinations particularly pointed out in the description and in the claims.

It is to be understood that both the foregoing general description and the following detailed description are exemplary and explanatory only and are intended to provide a further explanation of the present invention, as claimed.

### BRIEF DESCRIPTION OF THE DRAWINGS

The accompanying drawings, which are incorporated in and constitute a part of this application, illustrate features in various embodiments of the present invention and, together with the description, serve to explain the principles of the present invention. In different figures various features are often designated with identical reference numerals and related items are often designated with the same reference and with a letter suffix appended.

FIG. 1 is a timeline and block diagram of an embodiment of the present invention in broad, basic functional aspects of a friction welding system;

FIG. 2 is a schematic representation of one embodiment of an electric portable friction welding system in accordance with the present invention;

FIG. 3 is a simplified illustration taken in cross section along the longitudinal axis through major components in one embodiment of an electric portable friction welding system in accordance with the present invention;

FIG. 4 is a cross sectional view taken along the longitudinal axis through major components in one embodiment of an electric portable friction welding system in accordance with the present invention;

FIG. 5 is a cross sectional view taken along the longitudinal axis through a portion of an electric portable friction welding system in accordance with an embodiment of the present invention;

FIG. 6 is a side elevational view of an electric portable friction welding system in accordance with an embodiment of the present invention with end caps removed;

FIG. 7 is another side elevational view of the illustrative electric portable friction welding system of FIG. 6 with end caps in place;

FIG. 8 is a perspective view of the illustrative electric portable friction welding system of FIG. 7;

FIG. 9 is a partial cross-sectional view taken through the longitudinal axis of a portion an electric portable friction welding system of one embodiment of the present invention;

FIG. 10 is a perspective view of an electric portable friction welding system of the illustrative embodiment of FIG. 9 with the lower end cap removed;

FIG. 11A is a cross sectional view taken at the longitudinal axis of an electric portable friction welding system and focusing on one embodiment of an autoloading system;

FIG. 11B is an elevational view of the illustrative embodiment of FIG. 11A with the outer housing removed;

FIG. 11C is a closeup perspective view of the electric portable friction welding system embodiment taken at circle 11C of FIG. 10 highlighting the autoload device of that illustrative embodiment;

FIG. 11D illustrates select isolated elements in a simplified view of the autoload device of FIG. 11A;

FIG. 11E illustrates a side elevational view of a subset of the autoload elements of FIG. 11D;

FIG. 12 is a flow diagram illustrative on one embodiment for the weld sequence;

FIG. 13A schematically illustrates one embodiment of an electric portable friction welding system in an autonomous underwater vehicle application;

FIG. 13B schematically illustrates one embodiment of an electric portable friction welding system in a remotely operated vehicle application;

FIGS. 14A and 14B provide a rendering of an illustrative system diagram of one underwater vehicle portable friction welding system embodiment;

FIG. 15 is an illustrative system diagram of one docking station portable friction welding system embodiment;

FIG. 16 is an illustrative system diagram of one cloud-based computer system embodiment;

FIG. 17 is an illustrative system diagram of one portable friction welder system software environment embodiment;

FIG. 18 is a flow diagram of one illustrative embodiment of a vehicle registration and task launch process in a portable friction welding system;

FIG. 19 is a flow diagram of one embodiment of a portable fusion welder system operator welding instruction addition lifecycle;

FIG. 20 is a flow diagram of one embodiment of a system monitoring instruction process in a portable friction welder system; and

FIGS. 21A and 21B provide a flow diagram of one embodiment of a task process flow in a portable friction welder system.

### DETAILED DESCRIPTION OF THE INVENTION

It is to be understood that the apparatus and methods described herein may be implemented in various forms and those skilled at the art should appreciate that they can readily use the disclosed conception and specific illustrative embodiments as a basis for designing or modifying other structures for carrying out the same purposes of the present invention as defined by the patent claims. The detailed description describes several distinct embodiments, and it will be understood that not all of that detail, while exemplary, is essential to the claimed invention. Thus, other modifications, changes and substitutions are intended to the foregoing disclosure and, in some instances, some features of the invention will be employed without a corresponding use of other features. Accordingly, it is appropriate for the patent claims be construed broadly and, in a manner, consistent with the spirit and scope of the invention herein.

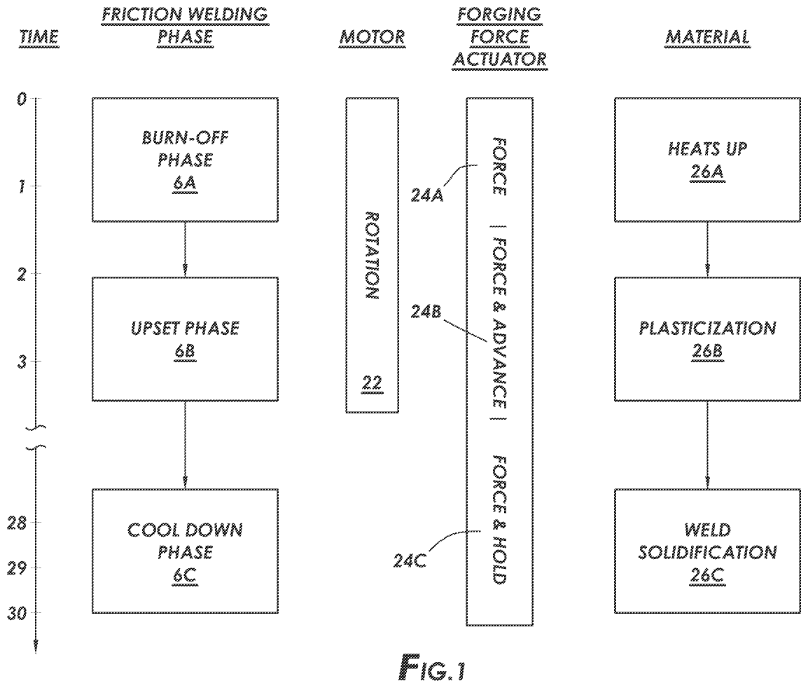

Friction welding processes have been in use in factory settings for decades in extremely large, heavy bed lathe machines. More recently, portable friction welding devices have been developed to allow friction welding deployment in the field. FIG. 1 provides a rough timeline for welding with a portable friction welding system. This time-line correlates the friction welding stage with what is happening in the motor, the forging force actuator and in the materials to be joined, respectively. Friction welding has three stages, a burn off phase 6A, and upset phase 6B and a cool down phase 6C. In the burn off phase, the motor provides rotation 22 to the fixture and a forging force actuator produces a linear force 24A driving the rotating fixture against the substrate such that the friction produces substantial localized energy at the intersection of the fixture and the substrate, see stage 26A for the material. Rotation 22 in the motor continues in upset phase 6B and further linear forging force begins to cause advancement 24B of the fixture into the substrate as the materials at the intersection to plasticize, see step 26B for the material. Rotation 22 from the motor ceases with advancement of the fixture into the substrate. The friction welding process enters cool down phase 6C and the weld material joining the fixture and the substrate solidifies 26C. Linear forging force 24C is maintained throughout the cool down phase 6C. The automated cycle typically takes two to four seconds and ceases when the motor cuts off, rotation 22 ceases and the holding forging force 24C continues through a dwell period. A wait time on the order of twenty to thirty seconds in most circumstances completes the cool down or dwell phase 6C and weld solidification 26C and the forging force can be released, and the tool removed from the installed fixture.

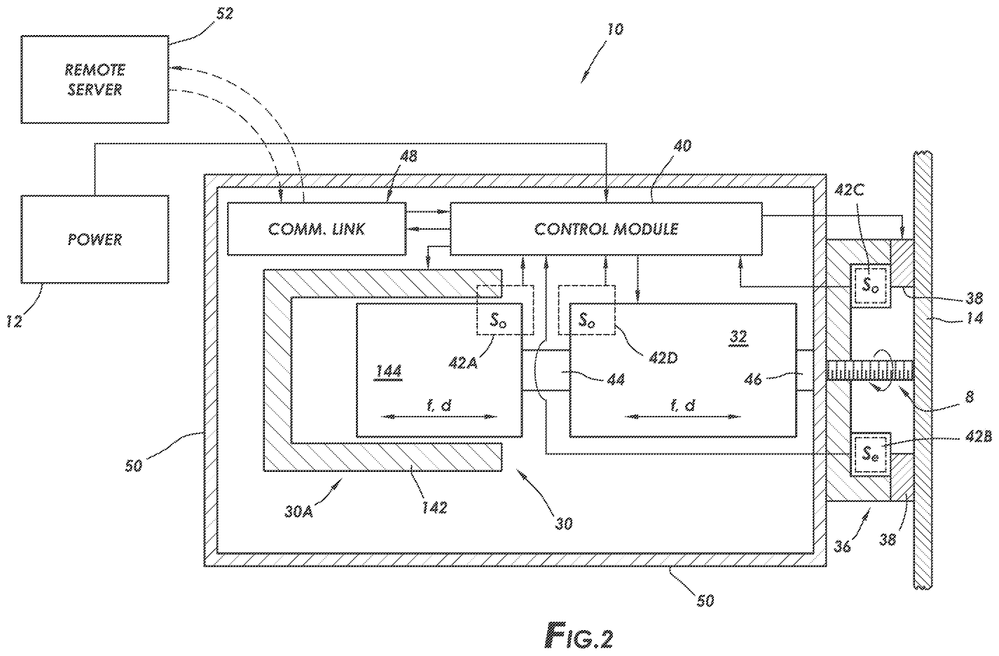

FIG. 2 is a schematic representation of major components of one embodiment of an electric portable friction welding system 10 for bonding an element, fixture or workpiece 8 (most often in the form of an externally threaded stud or an internally threaded boss) to a substrate 14. System 10 has an electric power supply 12 that may be AC or DC and may include battery, in-situ generation, or by a power transmission line. Power supply 12 is connected to control module 40. The control module supplies power and, potentially, instructions to linear actuator 30, motor 32 and potentially to clamp 36. In this illustrative embodiment, clamp 36 deploys electro-magnet 38 for selectively engaging portable friction welding system 10 in position on substrate 14 and secure against reactive forces to the forging force and torque transmitted through fixture or stud 8 to make up a friction weld. It will be appreciated that clamp 36 may be based on other technologies including, but not limited to, vacuum clamps and gripping devices.

Clamp 36 is a convenient place to mount a number of environmental sensors (“Sₑ”) directed to what is external to housing 50, the environmental sensor suite is designated generally as 42B for parameters selected from a group comprising ultrasonic transducers, cameras, proximity sensors, temperature sensors, depth sensors and metallurgical identification and are in communication with the control module. It should be noted that some of the environmental parameters may serve multiple purposes. For instance, the ultrasonic transducer is used to determine whether substrate 14 has the structural integrity to receive a fixture; may determine the thickness of protective coating, rust or biofouling buildup that must be passed through to weld to the substrate; or may be used to evaluate the soundness of a weld just executed. In addition to sensor interrogation, the operator may use communication link 48 to input environmental data, e.g., metallurgy of the substrate and fixture into the data. It is also noted that a number of parameters may, depending upon context, act as both operational and environmental parameters.

Any clamp operations parameters (“Sₒ”) applicable to the clamp, e.g., magnetic flux, pressure in the case of a vacuum clamp, strain indicative of reactive force being absorbed, and other sensors for operational parameters are generically designated here as sensor suite 42C.

In this illustration, linear actuator 30 is a voice coil 30A deploying permanent magnetic field assembly 142 and coil assembly 144. Here, sensors 42A for operating parameters (“Sₒ”) associated with linear actuator 30 address parameters selected from a group comprising, voltage, amperage, forging force, distance of axial travel, speed of axial travel, temperature and humidity.

Rotary motor 32 is connected to linear actuator 30 through coupling 44 to pass through the forging force and linear motion to collet 46 at the motor output and to fixture or stud 8 mounted in the collet. The rotation of the fixture or stud is denoted by arrow “r” in FIG. 2. Sensor(s) 42D generally represents one or more sensors for parameters of motor operations Sₒ from a group comprising speed (RPM), voltage, amperage, temperature and humidity.

A housing 50 is illustrated surrounding forge force generator or linear actuator 30, rotary motor 32, and control and communications components here generally introduced as a control module 40 and a communications link 48. It should be appreciated that the actual hardware for housing 50 may comprise more than a single housing, e.g., providing bearing surfaces slidably engaging the forging force generator and the rotary motor while another seals out the elements and provides protection for additional components.

Control module 40 receives the output of environmental sensor suite Sₑ 42B and operational sensor suites Sₒ designated 42A, 42B, 42C, and 42D into processing hardware containing a selected weld design model of encoded instructions developed as a function of parameters of this sensor input. This facilitates allowing real time active control during welding processes that manages operation of linear actuator 30 and rotary motor 32 independently for each within the specified parameters of the encoded instructions for a given recipe. Further, this may allow coordination of the operation of the linear actuator and the rotary motor to what is happening in the weld, e.g., transition between phases of the welding process according or other parameters that become encoded instructions for the recipe and are monitored, directly or indirectly, by sensor input. The resulting active control instructions are communicated to linear actuator 30, rotary motor 32, and clamp 36.

Control module 40 also sends and receives to a communications link 48. The communications link receives information such as the encoded instructions (job specific weld recipe) for the present job and may be as simple as a port to receive information through physical intervention such as by uploading via a thumb drive or from a temporary connection with a laptop through the ethernet port. However, much greater versatility and opportunities to optimize performance can be obtained when communications link 48 is connected to a remote server 52 for sending and receiving information, whether by tethering cable, Bluetooth, satellite, Wi-Fi or otherwise.

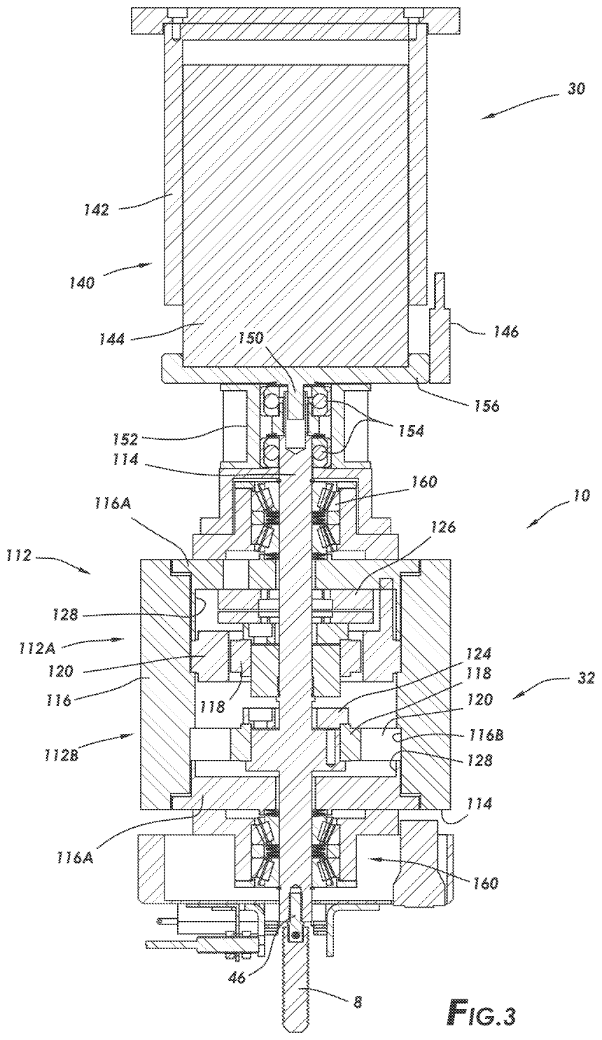

FIG. 3 introduces an illustrative example of hardware for a modular, electrical portable friction welding system 10 in accordance with one embodiment of the present invention. FIG. 3 illustrates a cross-section taken along the longitudinal axis of several major components of welding system 10, including forging force generator or linear actuator 30 and rotary motor assembly 32. Various components, e.g., many of the sensor suites, the inner bearing housing and the outer housing have been omitted from this figure for the sake of illustrative clarity for the other components.

In this embodiment, motor assembly 32 is supplied by double stator motor assembly 112 including a rotor/stator pairing first stator 112A and a second rotor/stator paring 112B ganged on shaft 114. The double ganged stator assembly of this embodiment can provide efficiency in a small package while delivering the required speed and power. However, those skilled in the art and armed with this disclosure could design single stator assemblies suitable to purpose.

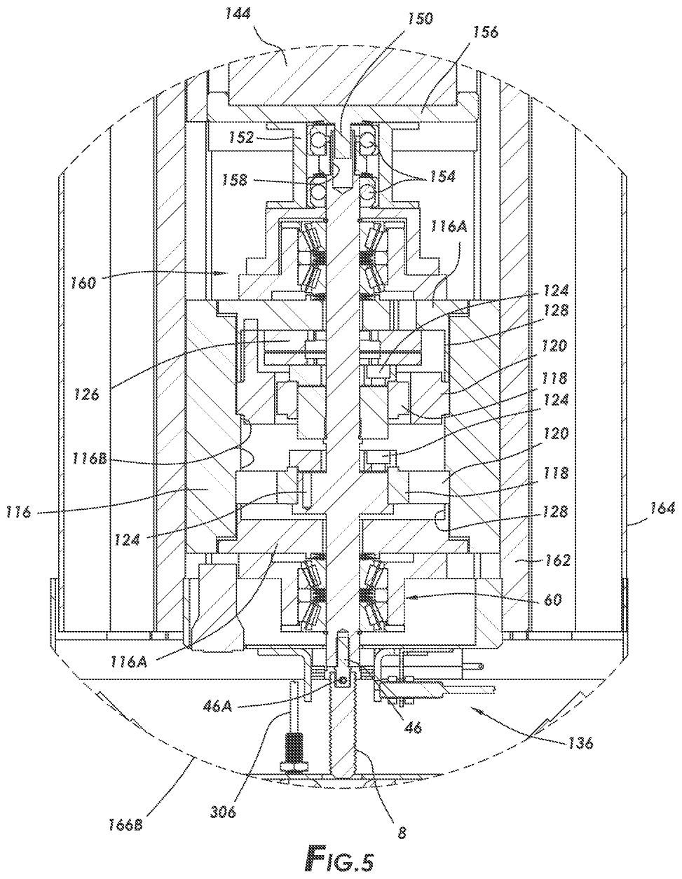

Each of the rotor/stator pairs of motor assembly 112 is placed within motor housing 116 and has rotor 118, rotor shaft clamp 124 securing the rotor to shaft 114, a stator 120, and a stator clamp 128 securing the stator to motor housing 116. The motor housing is provided with end walls 116A and in this illustrative example stator clamps 128 are formed by flanges extending from end walls 116A which serve to wedge the stators tightly against shoulders 116B on the inside of motor housing 116. The speed as revolutions per minute (RPM) is monitored by encoder 126, the encoder itself having a rotor and stator to measure relative movement therebetween. Refer also to FIG. 5 which is a partial cross section of welding tool 10 which enlarges the illustration of motor assembly 32.

Returning again to FIG. 3, in this illustrative embodiment, forging force generator or linear actuator 30 is supplied by a voice coil linear motor 140. Voice coils are also known as non-commuted DC linear actuators and provide controlled force over their stroke and this force can be reversed by changing the polarity of electrical input. In this illustrative example, voice coil 140 has a permanent magnetic field assembly 142, a powered coil assembly 144, and is provided with an integrated position sensor, encoder 146.

The forging force generated by voice coil 140 is communicated to rotary motor 30 through coupling 148. The coupling passes the forging force to the motor housing 116 through thrust block 152. A forging plate 156 is connected to the base of coil assembly 144 and includes a forging alignment pin 150 which is received in an open in the end of shaft 114 secure axial alignment of forging pin 150 within bushing 158 with this end of motor shaft. This fitting allows for a gap such that while axial alignment is secured, forging force is not presented directly from forging alignment pin 150 to the end of motor shaft 114. Ball bearing assembly or races 154 between the interior of thrust block 152 and the exterior of both forging alignment pin 150 and motor shaft 114 further secure this axial alignment.

Accordingly, coil assembly 144 and motor assembly 32 move together in response to forging force. However, the forging force is ultimately applied to fixture 8 which is connected to motor shaft 114 through collet 46. Thrust bearings or similar arrangements are then necessary to allow transfer of the forging force to the fixture while preventing relative axial movement of motor shaft 114 within motor housing 116 and consequential misalignment of rotors 118 and stators 120. In this embodiment, tapered roller bearing assemblies 160 provide this load isolating function and engage motor shaft 114 and motor housing 116 where the motor shaft exits each end of the motor housing.

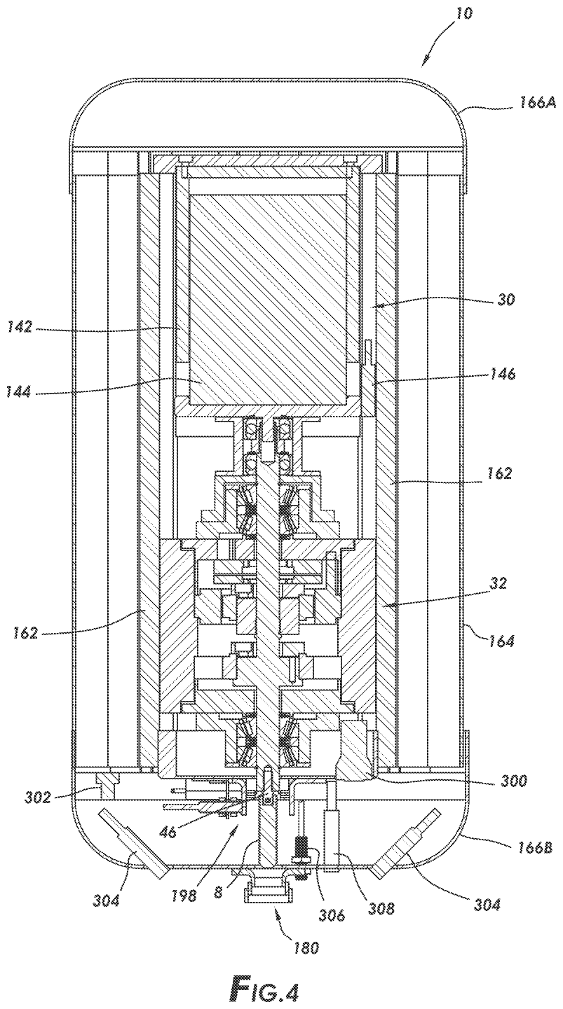

The cross sections of FIGS. 4, 5 introduce other components of this illustrative embodiment that were omitted in simplifying FIG. 3. For instance, inner bearing housing 162 secures permanent magnetic field assembly 142 fixedly in place while engaging motor housing 116 so as to secure against axial rotation of the motor housing in relation to linear actuator 30 while allowing axial sliding of the rotary motor relative to a stroke of linear actuator 30, e.g., with the engagement of keys against longitudinal shoulders or in tracks, not shown. With appropriate gaskets and bushings, the inside of inner bearing housing 162 can provide a secure, water resistant environment for electronic components, control and communication modules. This sealed inner bearing housing can also provide isolation from explosive gases in hazardous environments. Refer again to FIG. 2. This space can also include important operational sensors. Heat sensors can support a preemptive shut down if the voice coil or the motor start to overheat. And sensors can also be included for water incursion, e.g., humidity sensors. This can afford an opportunity to timely retrieve the portable friction welding tool from an underwater operation should seals and gaskets protecting electrical and electronic components begin to leak.

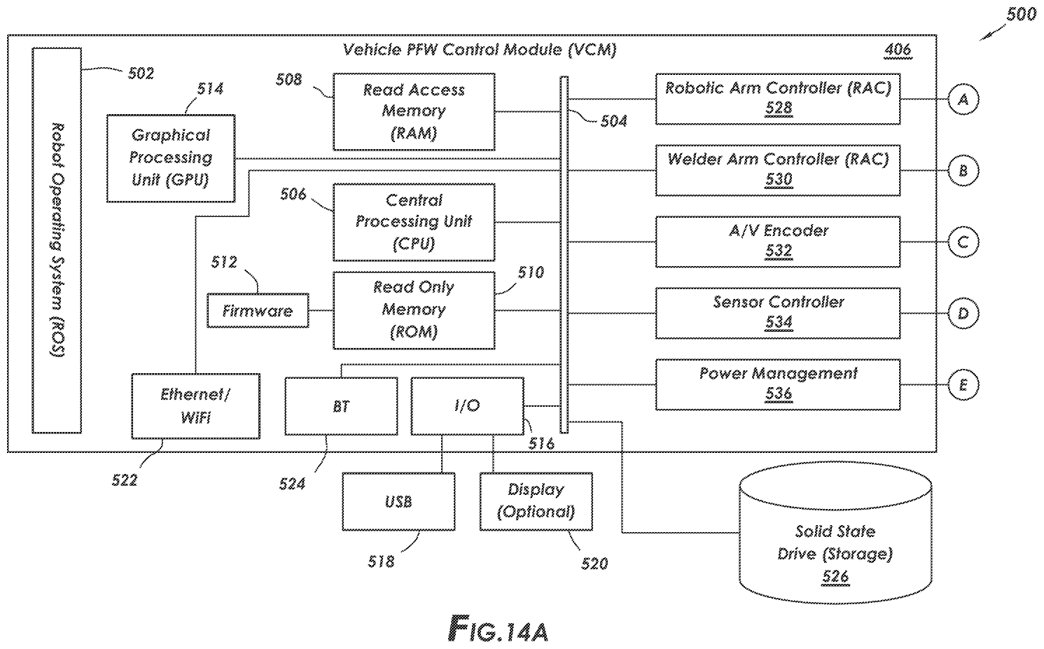

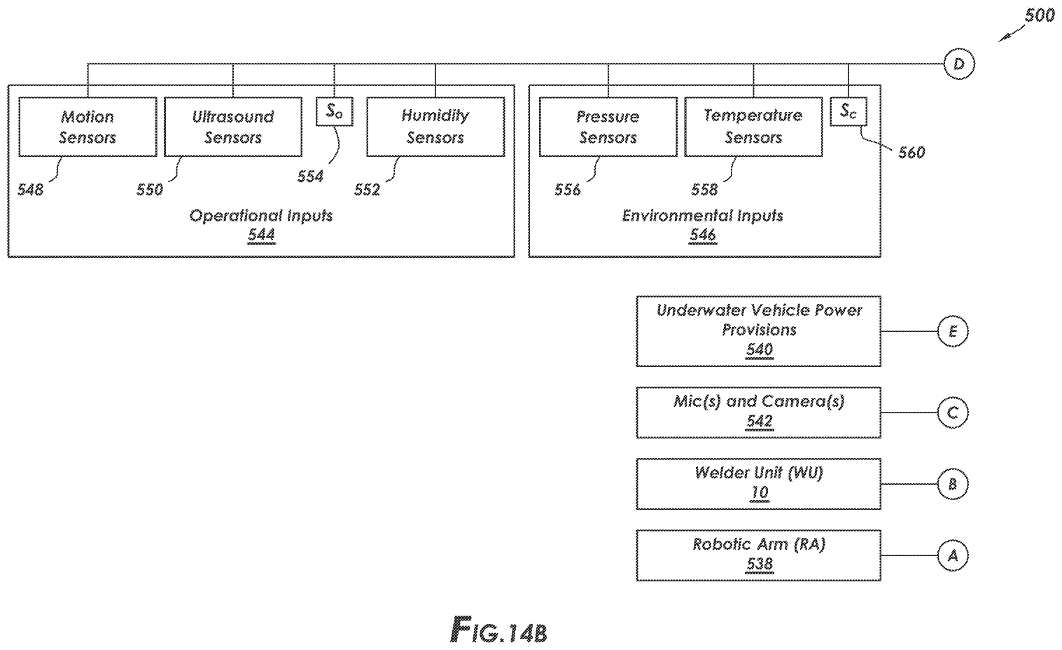

However, an outer housing 164 including upper and lower outer housing end caps 166A and 166B, respectively, can provide additional protection and allow a clean exterior that facilitates inserting a modular, electric friction welder into other host vehicles for transport and application in the field. An example of two such host vehicles and applications are illustrated in FIGS. 13A and 13B.

Returning to FIG. 4, a number of sensors are illustrated associated with lower outer housing cap 166B. See also FIG. 2. The illustrated sensors include two offset cameras 304 arranged to provide a stereoscopic view of the target weld area upon approach to a substrate. A third camera 304A can provide a direct, head-on view to the target weld area on approach. Accurate and efficient approach can also be facilitated with a pressure transducer 302 for an ongoing depth read-out on approach in underwater applications and a proximity sensor 306 can facilitate a soft landing. A temperature sensor such as a calibrated thermistor can also help understanding of environmental issues affecting welding operations. For instance, cold temperatures and/or conducting welding underwater can affect welding operation in both what is necessary to achieve plasticity and in how the quench rate affects the metallurgy determining weld strength.

The output of the sensors is communicated to control module 40 and can be relayed through communications link 48 to remote server 52. Refer to FIG. 2 for a general discussion. A much more detailed example is discussed later in this application.

FIG. 4 also introduces components autoloading device 198 which automatically bring successive fixtures 8 into position to be captured by collet 46 illustrated here as a drive member with a trapped, spring-loaded ball 46A that seats inside of a recess in the end of the fixture. See FIG. 5.

Returning to FIG. 4, an ultrasonic transducer 300 can help scout a prospective weld location, e.g., it can determine if the substrate has the requisite structural integrity and it can determine the depth of protective coatings and of rust and/or biofouling agents such as algae, barnacles, or the like. Remedial actions ranging from moving the weld to a new location, directing cleaning activities, and adjusting the depth settings for the fixture may be appropriate. The ultrasonic transducer may also help evaluate the quality of the resulting weld. This is important both in affording real time input for instant remedial action and to provide an important parameter in uploading information through the communications link, see FIG. 2.

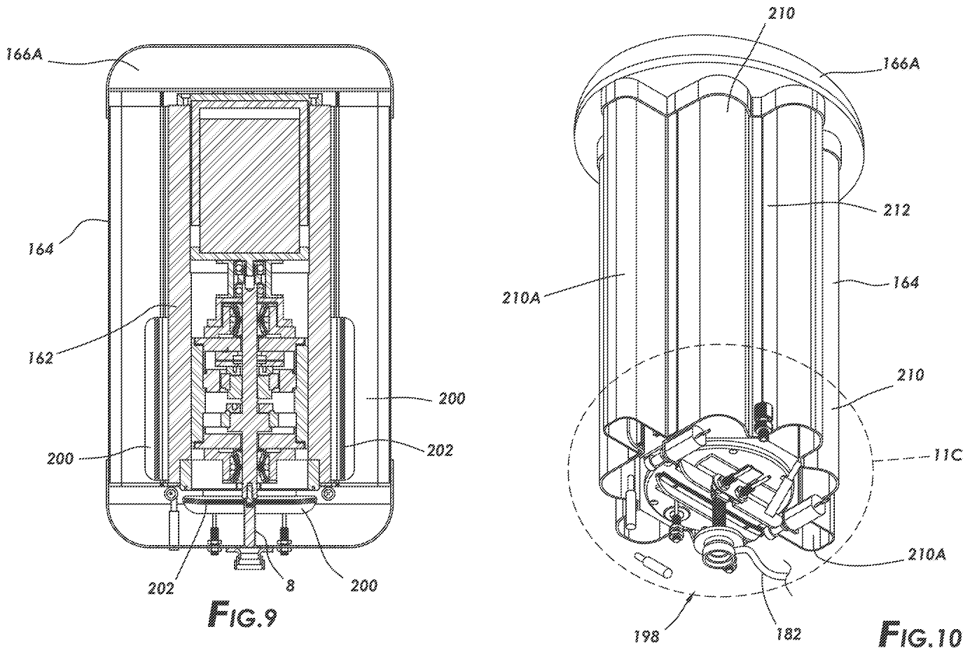

FIG. 4 also introduces shroud 180 in the form of a telescoping metal open ended cylinder that surrounds fixture 8 during welding. An influx of an inert gas is flooded into the shroud from gas provisions 182 illustrated as a gas line in FIG. 10 that could include, e.g., a pressurized tank (not shown) supplying inert gas for terrestrial applications in explosive atmosphere. This purges the explosive gas and the continued flow of inert gas, within shroud 180, continues to isolate the immediate weld area from the explosive atmosphere during the period of risk. Alternatively, underwater applications may use an inert gas or even compressed air to modify heat transfer characteristics at the immediate weld site during the weld by effectively isolating weld activities from water incursion.

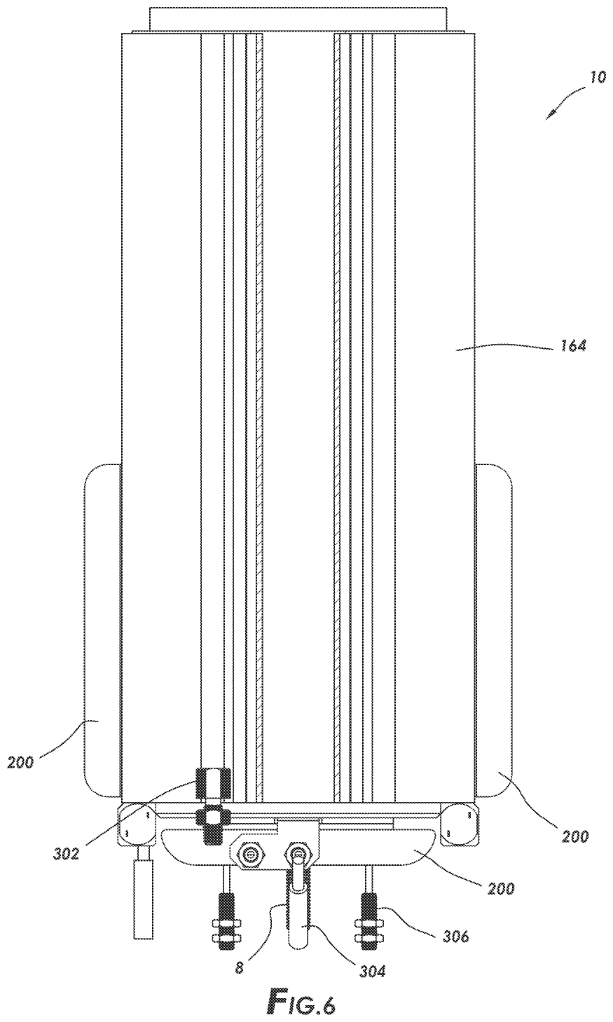

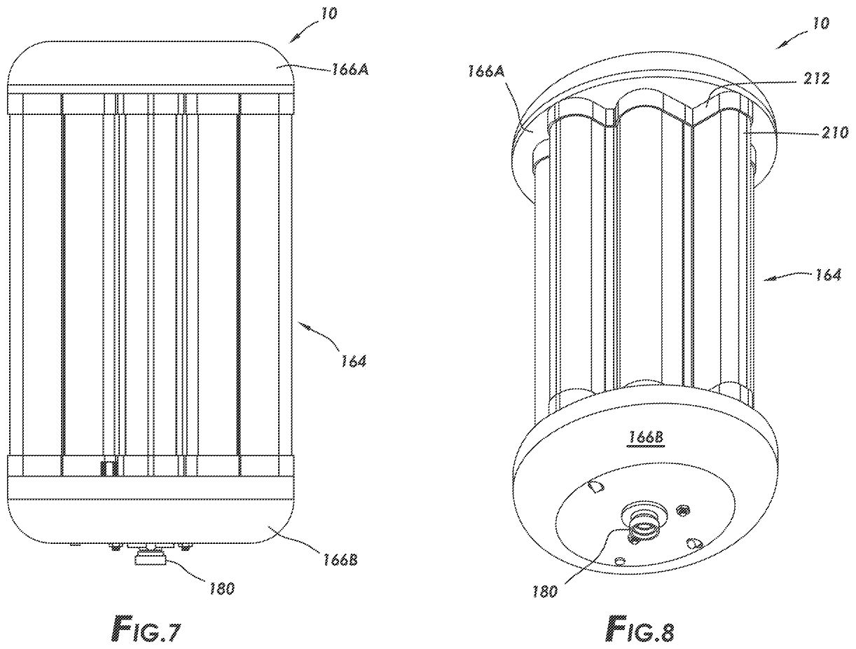

FIGS. 6-8 illustrate the exterior of outer housing 162 of portable friction welding tool 10. FIG. 7 is a side elevational view and FIG. 8 is a perspective view of the tool exterior. FIG. 6 is a partially cross sectioned, partial side elevational view of the portable friction welding tool with upper outer housing end cap 166A and lower outer housing end cap 166B removed. This affords a side profile view of side or protective rails 200 that guard a track and fixtures secured to a tape fed through that track. See also track 202 in the cross section through this profile view presented in FIG. 9. FIGS. 7, 8 and 10 illustrate a corrugated shape of ridges 210 and valleys 212 to exterior housing 164 that is convenient for enclosing side rails 200, tracks 202 and the passage of fixtures 8 through automatic feed 198 under ridges 210A. The corrugation also affords a greater strength to weight ratio for the wall of outer housing 164.

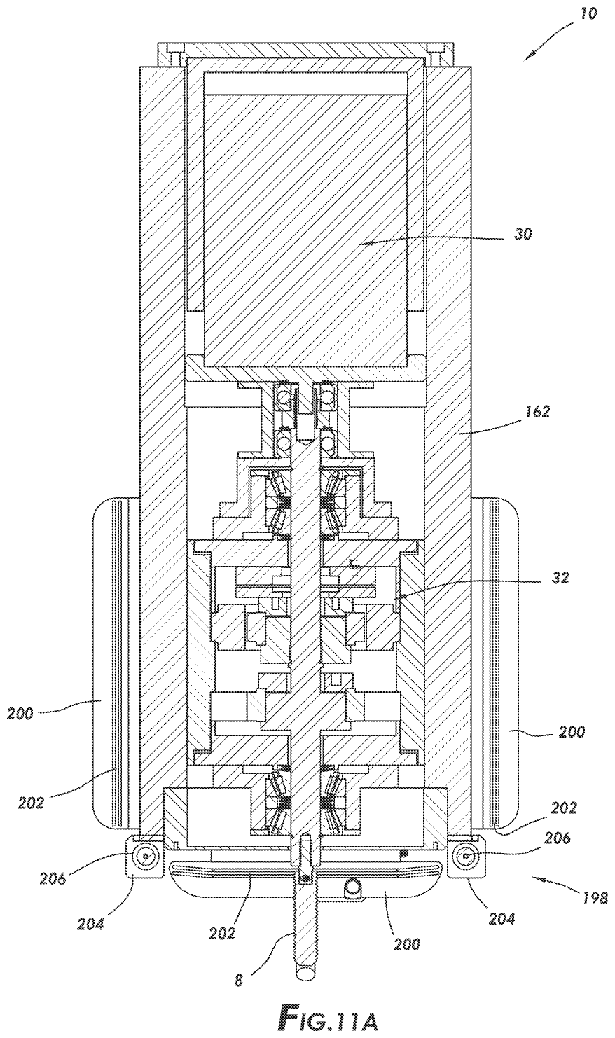

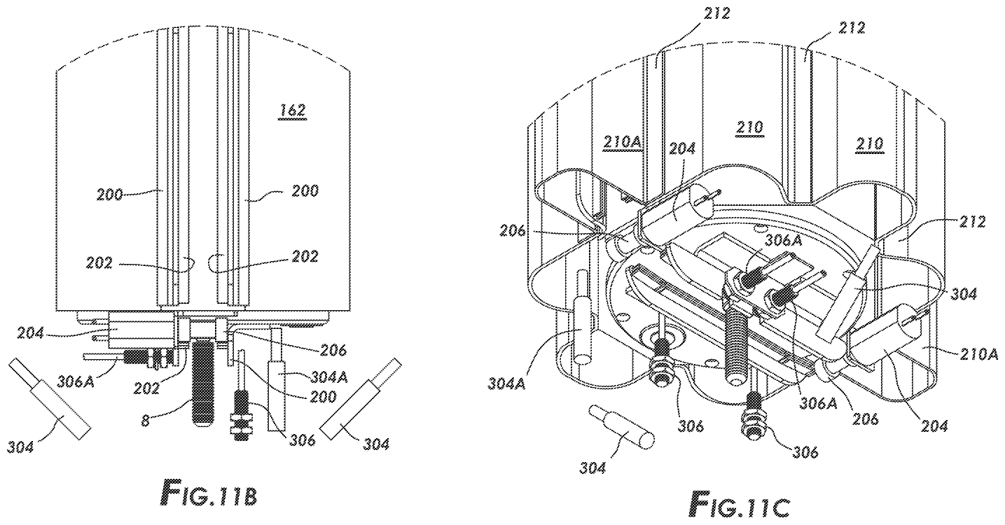

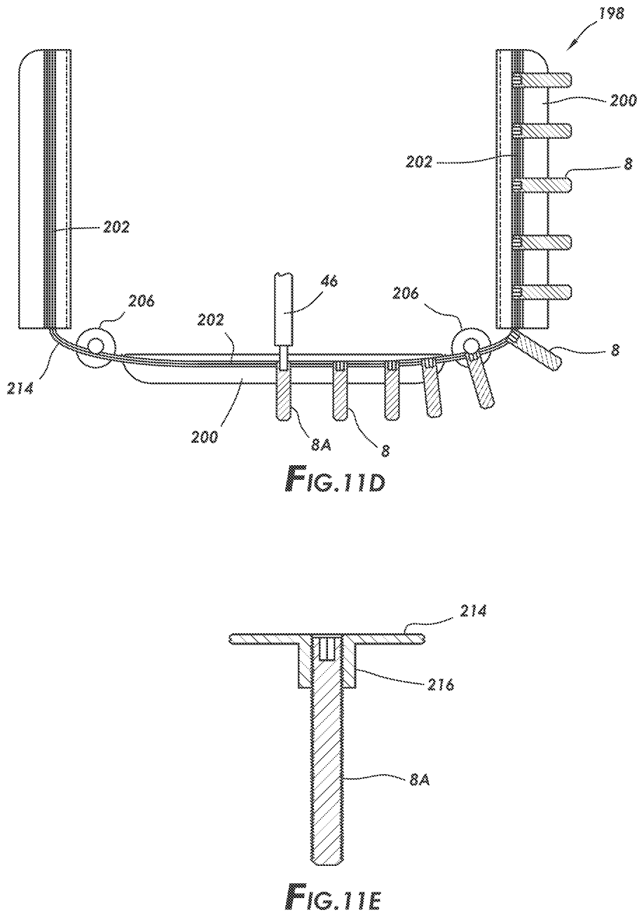

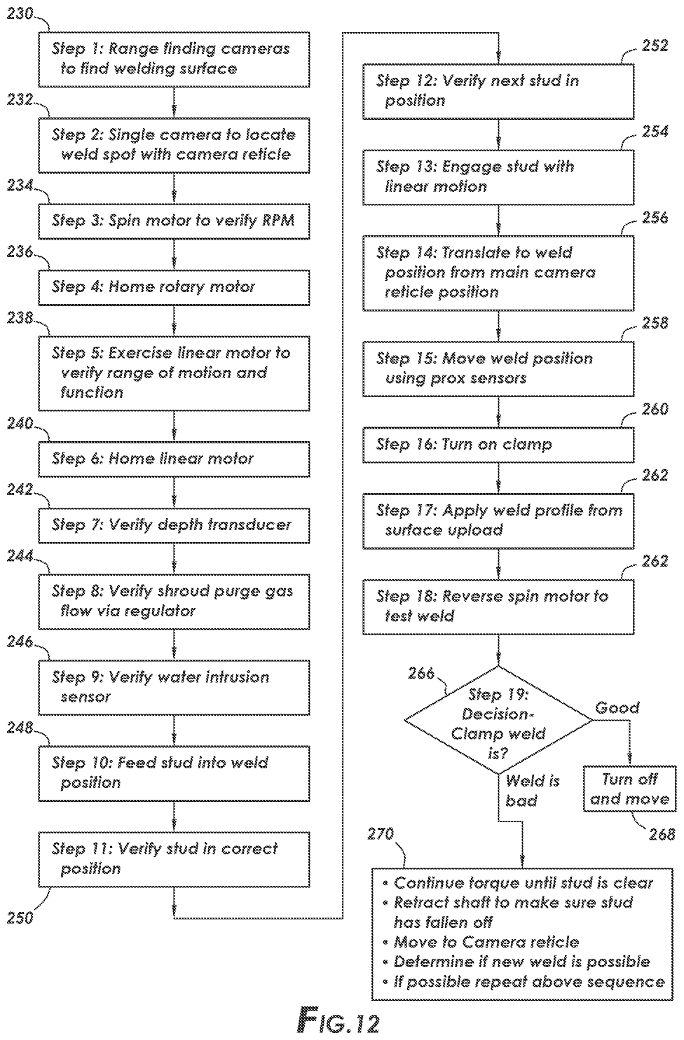

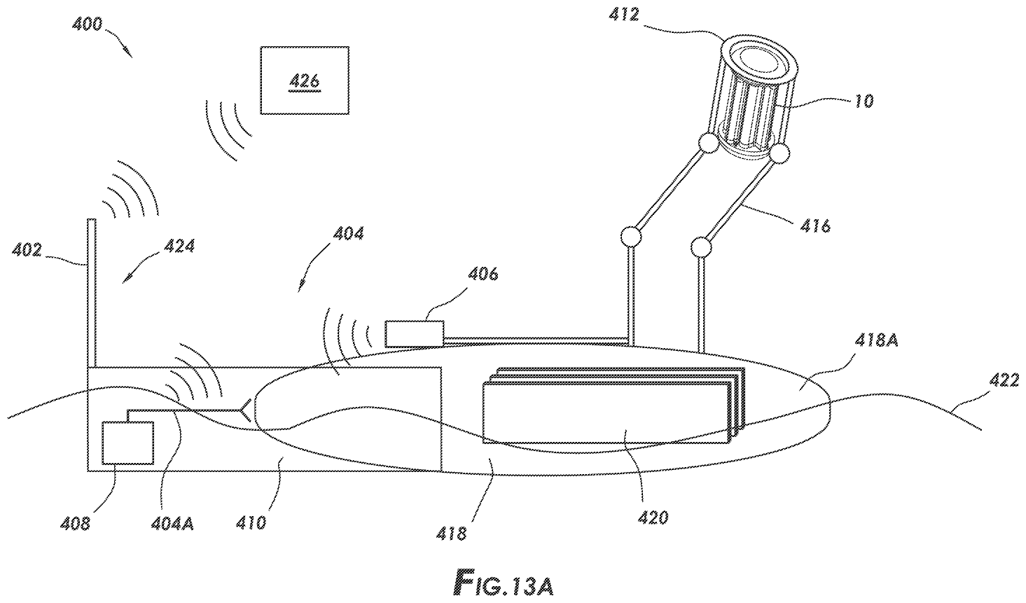

FIGS. 11A-11D detail one embodiment for fixture auto-loading device 198 for fixtures 8. FIG. 11A is a cross section bisecting protective side rails 200 and tape receiving tracks 202. Small servomotors 204 with sprocket drives 206 feed the perforated tape to which a succession of fixture is mounted through track 202 between rails 200. FIG. 11B illustrates track 202 and protective side rails 200 mounted onto the exterior of inner bearing housing 162. This figure also provides a side view of servomotor 204 and sprocket drive 206. Note, the protruding sprockets have been deleted from the illustration for the purpose of simplifying the drawing. Though sprockets offer the benefits of a very positive feed mechanism, taught tape and various friction drives are an alternative. In this embodiment, correct position of the fixture that is up for installation is identified as between proximity sensors 306A.

FIGS. 11D and 11E are further simplified drawings of autofeed provisions 198 focused on fixtures 8 and 8A carried within seats 216 advancing on tape 214. The edges of the tape engage tracks 202 and is spooled between drives 206 which may be, e.g., sprockets or tensioned friction wheels. FIG. 11E is a close up of fixture 8 here a stud, that is next in line to engage collet 46. After engagement with collet 46, fixture 8A is driven out of seat 216 and is ready for installation.

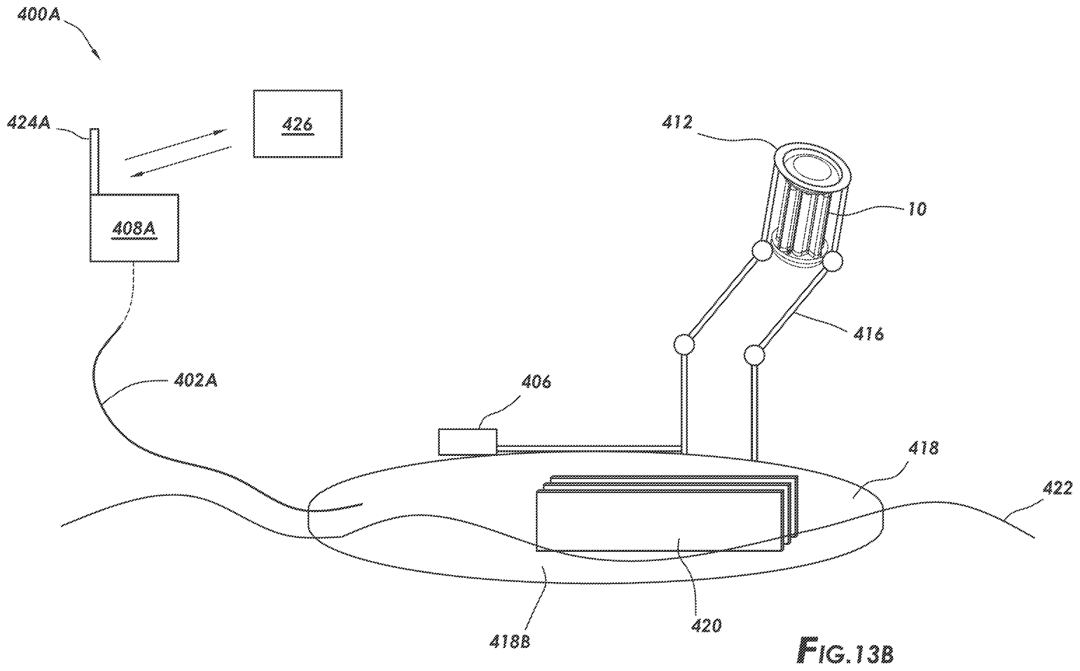

One illustrative weld sequence in accordance with an embodiment of the present invention is illustrated in the steps of FIG. 12 which uses a remotely operated robotic means to transport portable friction welding tool 10 to the desired vicinity for the underwater installation of a fixture using range finding offset stereoscopic cameras 304 in step 1 (designated 230) and a single camera with a camera reticle to locate the exact weld spot in step 2 (designated 232). Further, a pressure transducer 302 can help verify that the depth at the location agrees with job planning as noted in step 7 (designated 242), but it will be appreciated that this may be accomplished at any point in preparation to find the site. The suitability of installation at the planned site is confirmed with ultrasonic transducer 300.

Pre-op procedures to ready the portable frictions welder include spinning the motor to verify RPM as step 3 (designated 234), then returning the rotary motor 32 to a home position. Next, the linear actuator motor 30 is exercised and its function and range is verified, e.g., with encoder 146, (see step 5, designated 238) before returning to its home position as step 6 (designated 240). Similarly, proper working of shroud and gas purge system 180 is confirmed (step 8, designated 244) and the absence of water intrusion is verified with inquiry through an appropriate operational sensor Sₒ such as a humidity sensor in step 9 which is designated 246 in FIG. 12.

With the friction welding unit prepared and ready to perform a job, the next stud is fed into position with automatic feed provisions 198 (see step 10, designated 248) and verified to be in position as step 11 (designated 250). The feed may be further confirmed by verifying that the next stud following is also in position (see step 12, designed 252). Advancing linear actuator 30 then drives fixture 8 to engage with collet 46. See step 13 designated 254 in FIG. 12.

Portable friction welding tool 10 is translated to final position for installing fixture 8 using main camera reticle positioning with camera 304A and proximity sensor 306. See, e.g., steps 14 and 15 designated 256 and 258 in the flow diagram of FIG. 12, respectively, and illustrative hardware in FIG. 11C. Once in position, the clamp is engaged, see step 16 (designated 260). Illustrative hardware is presented in FIG. 2 as magnetic clamps 38 which are energized in one embodiment of this step.

An important attribute facilitated by the present invention is the ability to execute the weld using a recipe of parameters unique to the particular job and defining the friction weld design model for an application. These instructions were previously uploaded to control module 40 are now executed in step 17 (designated 262) of this illustrative embodiment calling to apply the weld profile from the surface upload. Control module 40 sends instructions to independently and actively manage linear actuator 30 and rotary motor 32 to the uploaded performance criteria while coordinating transition through the weld phases interactively. After the conclusion of the dwell stage, weld integrity is tested, e.g., with ultrasonic inspection though transducer 300 or through a reverse motor spin test, see step 18 (designated 264) leading to the decision of step 19 (designated 270). If the weld is good, the clamp can be turned off and the system moved to a new location for installing the next fixture.

In the event that the weld does not pass inspection, the reverse spin may be torqued up to remove the poorly installed fixture. A lack of resistance upon withdrawal of the linear actuator is used to confirm fixture 8 has separated from substrate 14. Camera inspection is then used to determine if it is possible to repeat this sequence at this site.

Electronic control of electrical components that are actively and independently managed facilitates the simplicity of using a single power source and affords great flexibly to adjust performance to match the parameters of the recipe during the weld and to and optimize operations overall.

FIGS. 13A and 13B introduce two exemplary applications deploying through a host vehicle 418, here as underwater autonomous vehicle (“UAV”) 418A and remotely operated vehicle (“ROV”) 418B, respectively. These examples are more broadly demonstrative of the flexibility to incorporate a friction welding module into a host vehicle 418 and it will be understood that these teachings are applicable to other terrestrial, areal, space and robotic applications. Further, FIGS. 13A and 13B illustrate an embodiment of computer system architecture that can facilitate the development, selection, and application of recipes of parameters to execute friction welding design plans suitable for a wide range of applications, circumstances and environmental conditions. Some of the determining factors in selecting an appropriate recipe include: strength requirements, size and metallurgy of the fixture; thickness and metallurgy of the substrate; surface conditions of the substrate including liners, coatings, rust and biofouling; environmental conditions including temperature, whether it is in the atmosphere, underwater and if so the current conditions, in space, in the presence of potentially explosive gases; etc.

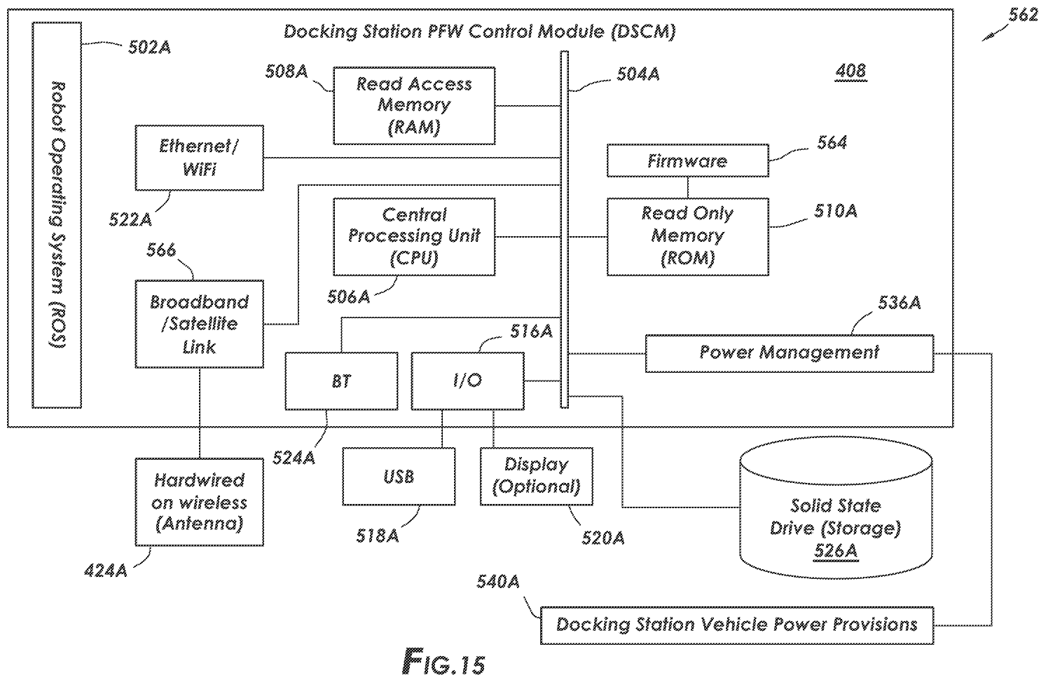

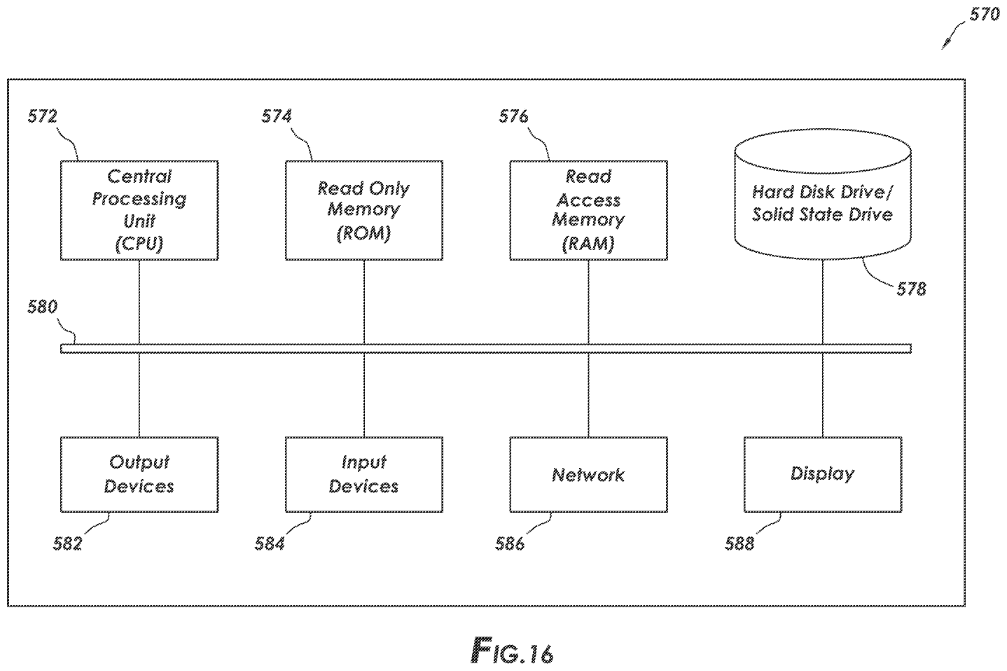

Illustrative embodiments addressing this potential will be further developed in FIGS. 14-21 addressing the design and operation of computer and software infrastructure to support and enhance operations.

FIG. 13A illustrates schematically a host vehicle 418, here in the form of an underwater autonomous vehicle (“UAV”) 418A for application for portable friction welding tool 10 combined into UAV system 400. In this example, modular, portable friction welding unit 10 is carried on an underwater vehicle 418A to which it is connected through articulated, telescopic robotic arms 416. Here provisions for controlling the flying of underwater vehicle 418A, manipulation of robotic arms 416, and control of portable friction welding unit 10 are all controlled through vehicle PFW control module 406. Alternatively, these diverse systems can be controlled through separate, but interactive, control systems.

In this illustrative embodiment, articulated arms 416 include an electro-magnet fashioned as ring 412 which serves as a clamp to secure the portable friction welder to a substrate 14 (see FIG. 2) to hold against reactive forces generated during welding operations. Magnetic ring 412 can also serve as a means to grab, manipulate and place lap plates 420 or other hardware carried on vehicle 418 to be installed using one or more fixtures that have been friction welded into place.

In this example, recipes of job instructions are loadable into vehicle PFW control module 406 to execute in placing one or more fixtures. However underwater vehicle 418A routinely and periodically returns to a docking station 410 which is located at a position convenient to area job sites. Here batteries driving underwear vehicle 418A, robotic arms 416, clamp 412 and portable friction welder 10 can be recharged. Further, vehicle PFW control module 406 can upload information about the last welds undertaken and download new or revised instructions for subsequent welds to be undertaken through a docking station PFW control module 408 carried on docking station 410. This communication may be managed through Bluetooth or other short-range wireless communication 404. Alternatively, vehicle PFW control module 406 can communicate with docking station PFW control module 408 through a special pathway incorporated in hard connection 404A formed in docking vehicle 418A at docking station 410, or even a signal modulation carried over the charging circuit established with hard connection 404A.

Docking station PFW control module 408 is, in turn, in communications with a remote server 426 through a communications link 402 here illustrated by antenna 424A on surface 422. Other circumstances might use other links. For instance, if the docking station is submerged, then communications link 402 might require an umbilical cable leading to a buoy supported antenna on the surface.

FIG. 13B illustrates another underwater deployment of the portable friction welding system 10. In this example an underwater tethered vehicle portable friction welding (PVW) system 400A is deployed. Here the host vehicle 418 for modular, portable friction welding unit 10 is tethered vehicle 418B, which presents similar articulated, telescopic robotic arms 416 to which the welder is attached. Again, provisions for controlling the flying of the underwater vehicle (here vehicle 418B), manipulation of robotic arms 416, and control of portable friction welding unit 10 are all controlled through vehicle PFW control module 406 or multiple, coordinated control systems.

And articulated arms 416 again include an electro-magnet fashioned as ring 412 serving as a clamp for securing the portable friction welder to a substrate 14 (see FIG. 2) to hold against reactive forces generated during welding operations. Similarly, magnetic ring 412 can also serve as a means to grab, manipulate and place lap plates 420 or other hardware carried on vehicle 418B to be installed using one or more fixtures that have been friction welded into place.

Here umbilical tether 402A provides underwater vehicle 418B with both power and communications and may, e.g., in a submerged application, lead all the way to the water's surface 422 or can lead to a docking station which is itself connected to the surface for electrical power and communications. Recipes of job instructions provide predefined parameters for producing effective welds using the present materials and under the present conditions and circumstances are loaded into vehicle PFW control module 406 to execute in placing one or more fixtures in real time, near real time, or between discrete jobs with vehicle PFW control module 406 communicating with remote server 426 either directly or through relay station PFW control module 408A as illustrated in FIG. 13B to upload job histories, i.e., information about the current or previous welds and downloading new or revised instructions or job specific welding recipes for subsequent welds.

Together FIGS. 14A and 14B provide an illustrative example of an underwater vehicle portable friction welding system diagram 500. A robot operating system 502 that can address the flying of vehicle 418 and manipulation of articulated telescoping robotic arms 416 resides in vehicle PFW control module 406. See also FIGS. 13A and 13B.

Vehicle PFW control module (VCM) 406 also houses main bus 504. Hardware and associated systems connected to the main bus comprise a central processing unit or CPU 506, read access memory (RAM) 508, read only memory (ROM) 510 which includes firmware 512 and graphical processing unit (GPU) 514.

Various communication provisions are also attached to main bus 504. Input/output provisions 516 communicate with systems external to VCM 406, such as USB drive port 518 and optional display 520. Communication provisions may further comprise cards for ethernet/WIFI 522 and for Bluetooth or other short-range wireless communications 524 connected to main bus 504. Specifics of the communication links to be included depend on the application. Solid state drive 526 may also be conveniently located external to VCM 406 yet in connection with main bus 504.

In addition, there are functional subsystems connected to main bus 504 and in this illustrative example this comprise robotic arm controller (RAC) 528, welder controller 530, A/V encoder 532, sensor controller 534 and power management 536.

Robotic arm 538 (see, e.g., FIGS. 13A and 13B) communicates with robotic arm controller 528, welding unit 10 is connected to welder controller 530, and electrical power provisions such as underwater vehicle power provisions 540 (see also tether element 402A of ROV application illustrated in FIG. 13B) is connected to power management 536. In addition, mic and cameras 542 (see also offset cameras 304 and camera 304A of FIG. 4) are connected to A/V encoder 532.

Sensor controller 534 is connected to a suite of operational inputs 544 and environmental inputs 546. In this example, operational sensors comprise motion sensors 548, ultrasound sensors 550, humidity sensors 552 and a Sₒ 554 which represents the potential for additional sensors including, but not limited to, others identified in this specification. Similarly, environmental inputs 546 of this illustrative example shows pressure sensors 556, temperature sensors 558 and Sₑ 560 which represents the potential for additional environmental sensors including, but not limited to, others identified in this specification.

FIG. 15 illustrates a docking station portable friction welding system diagram 562 and includes components inside docking station PFW Control module (DSCM) 408 (See FIG. 13A.). Returning to FIG. 15, updates and revisions to the robot operating system (ROS) 502A reside in the DSCM which also has a main bus 504A. Central processing unit (CPU) 506A, read access memory (RAM) 508A, and read only memory (ROM) 510A (with installed firmware 564) are each connected to main bus 504A.

Communications provisions within DSCM 408 in this example present a card for input/output 516A, ethernet/WIFI 522A, broadband/satellite link 566 or connections to hardwired communication or through an antenna 424A, and Bluetooth 524A or other short-range wireless communications, connected to bus 504A. Power management subsystem 536A and solid state drive 526A are also connected to main bus 504A.

Outside of DSCM 408, a USB drive port 518A and optional display 520A are connected to input/output provisions 516A within the DSCM and docking station vehicle power line 540A is connected to power management provision 536A.

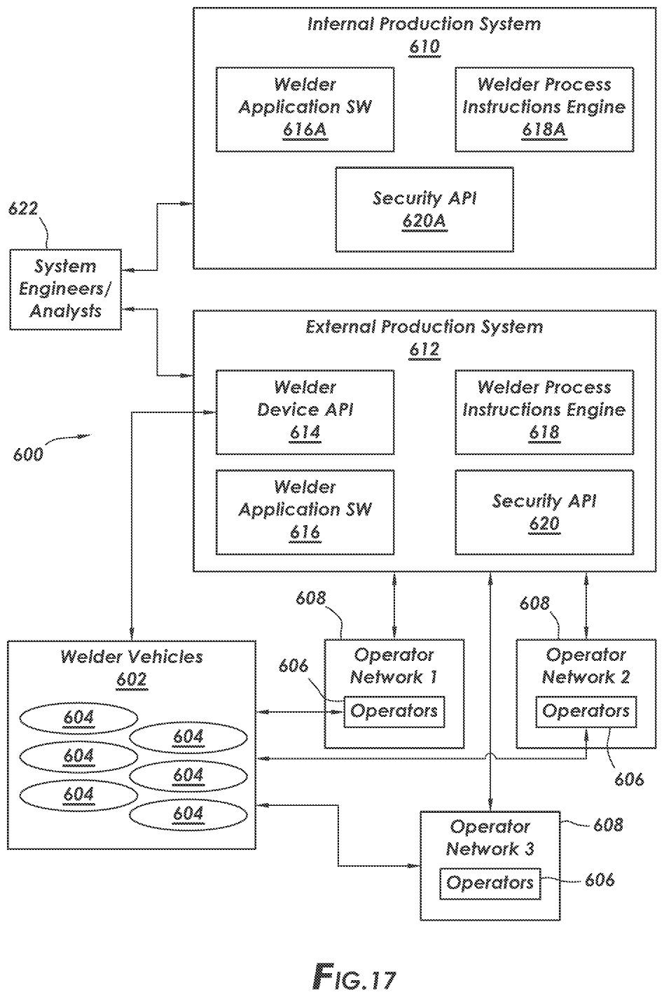

DSCM 408 in docking station 410 (see FIG. 13A) shuttles information between remote server 426 and VMC 406. The remote server can be owned and operated by the service provider, proprietary to the client and remote, or even not so remote, e.g., client facilities shipboard at the work site. FIG. 16 illustrates another option, cloud-based computer storage, see diagram 570. In this example, CPU 572, ROM 574, RAM 576 and solid-state drive 578 are each connected to bus 580. The bus also accepts output devices 582, input devices 584, network capabilities 586 and display 588.

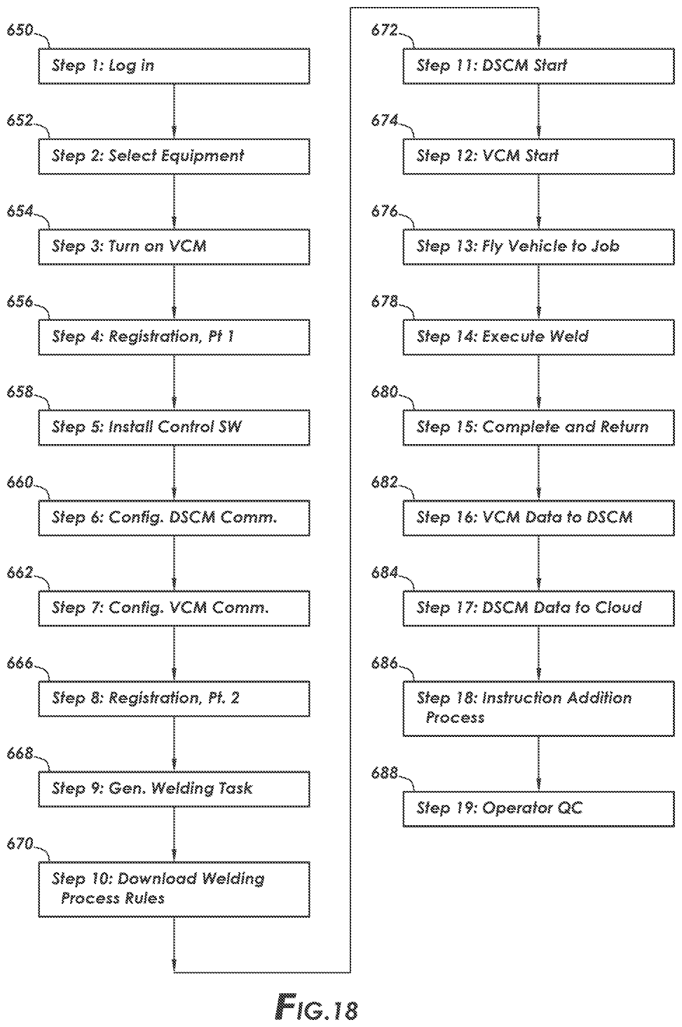

Cloud based storage may facilitate data collection, storage, and processing for improving and optimizing performance. FIG. 17 illustrates one embodiment of a PFW System Software Environment 600 deploying a fleet 602 of welder vehicles exemplified in vehicles 604 in service through multiple operators 606 through multiple operator networks 608.

An important feature of this illustrated software environment is the segregated internal and external production systems 610 and 612, respectively. The internal production system is a research and development environment, protected by its own security, e.g., security APIs 620A. Each of operators 606 pull one or more welder vehicles 604 from fleet 602. Each of the welder vehicles has been loaded with welder device APIs 614, welder application software 616, a current welder process instructions engine 618 and security APIs 620. As work progresses, information from each network 608 is uploaded to external production system 612 each time a welding vehicle docks. At this point, this information may be available to operators from that network 608 only. Data from the contributing operator of that specific network, collected during a specific job, at a specific job site, subject to specific conditions may prove useful for that operator in continuing work at that site even if all relevant conditions and parameters are not broadly applicable to other jobs or even fully catalogued.

However, the data may have broader implications and environmental and operational data is uploaded from the external production system to the vetting system, e.g., system engineers and analyst 622, to determine whether the data is suitable to add to the archive and training set within the internal production system. For instance, it is useful to screen whether the data has sufficient environmental data associated with the operational sensor data to give it context. And the vetting may find reasons to suspect that data produced is skewed such that it is not generally useful, e.g., evidence of tool malfunctions, lack of maintenance, tool misuse or other faults.

Useful data will be ported to the developmental environment of internal production system 610. Coding, new and improved algorithms and the products of AI training off the vetted data sets will be periodically reviewed by system engineers and analysts 622 and, as found appropriate, developmental welder application software 616A and recipes of developmental welder process instructions engines 618A will be published as revisions in the external production system 612, becoming the new standard for loading throughout fleet 602 where they are available to all operators for selection and application under similar circumstances. A different set of security APIs 620A protect and segregate internal production system 610.

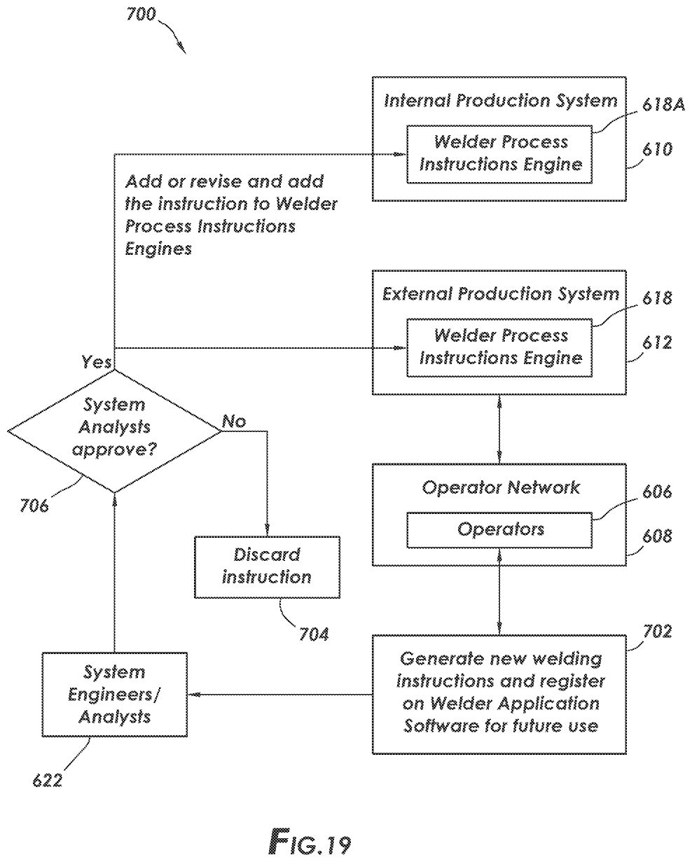

FIG. 18 is a flow chart of the PFW system vehicle registration and task launch process mainly viewed from the perspective of the operator. The following discussion of the steps of the embodiment of FIG. 18 should be read in the general context of the illustrative examples of FIGS. 13A and 13B and 14-16 unless otherwise noted. Those having ordinary skill in the art will be able to apply these aspects to other applications, including but not limited to manned and unmanned operations, terrestrial robots, and arial and space deployments.

Step 1 is denoted as log in 650. Operator 606 is a user who, e.g., may be a manufacturer, service supplier, or customer employee and the operator logs in to cloud-based software analogous to Welder Application Software 616 on FIG. 16, but stored on cloud based computer system 570 (FIG. 16) and accessed via web browser using previously provided user credentials. Returning to FIG. 18 for step 2, operator 606 (FIG. 17) “selects equipment” 652 on the user interface such as docking station and vehicle registration options.

The operator proceeds in Step 3 to turn on VCM 654, turning on the vehicle PFW control module (VCM 406 of FIG. 14) or integrated into the vehicle docking station 562 (FIG. 15). Operator 606 executes step 4 noted as registration, part 1 656 in FIG. 18 by registering docking station 408 (FIG. 13A) and vehicle set 604 (FIG. 17) with unique identification numbers on Welding Application software 616 (FIG. 17). Proceeding to step 5 identified as “install control software” 658, the operator installs computer installable control software intended for vehicle PFW control module 406 (FIG. 14) on his/her computer and connects to Docking Station Control Module (DSCM) 562 (FIG. 15) using USB 518 or another peer-to-peer protocol.

In step 6, “configuring DSCM communications” 660 in FIG. 18, the operator logs in to Docking Station Control Module (DSCM) 562 (FIG. 15) through its computer software interface, USB 518A. After a successful login, operator sets up Wi-Fi 522A or other broadband/satellite network 566 features on DSCM 562 and establishes its connectivity with the Internet. See FIG. 15. The operator then enables Bluetooth or another short-range wireless connectivity 524A on the DSCM. The DSCM's Bluetooth 524A acts as the master device.

Thereafter, in step 7 which is denoted as “configuring the VCM communications” 662 in FIG. 18, the operator uses the same software to connect Vehicle Control Module (VCM system 406 of FIG. 14 or VCM hardware of FIGS. 13A and 13B) using USB 518 or another peer-to-peer protocol. The operator then enables Bluetooth 524 or another short-range wireless protocol on VCM 406 and Bluetooth 524 of the VCM acts a slave device.

After a successful connection, registration (part 2) 666 of Step 8 completes registration. DSCM (subsystem 408 in FIG. 15) starts communicating with Welder Device API 614 located in external production environment 612 in FIG. 17 and completes the registration process, e.g., for docking station 408 and vehicle 418 of FIG. 13A. The registration process assigns this particular docking station and welder vehicle to the requesting operator's account.

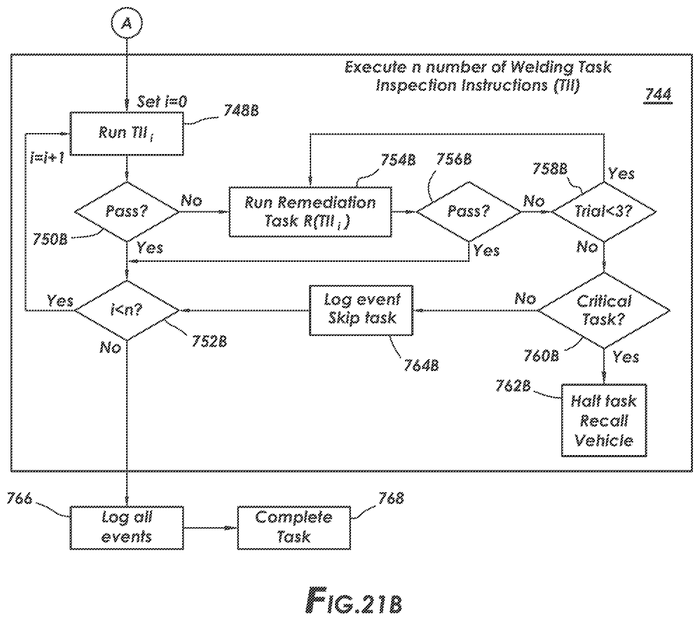

After registration is complete, step 9 addresses generating a welding task, illustrated in FIG. 18 as process element 668. Using Welder Application Software 616 (FIG. 17), the operator generates a new welding task or modifies/revises a previously generated welding task and saves the process details and gives the welding task start command which will be discussed later in connection with FIG. 21.

Step 10 of this process as illustrated in FIG. 18 is to download welding process rules 670. Docking station 408 (FIG. 13A) downloads the most recent welding process rules from engine 618 in external production environment 617 (FIG. 17) and stores the rules in DSCM storage 526A (FIG. 15).

In step 11 of the process is DSCM start 672 as illustrated in FIG. 18. Here, Welder Application Software 616 pushes the welding task instructions and data to docking station 408 via Welder Device API 614 and gives the welding task start command to DSCM 408. See FIGS. 15 and 17. Thereafter, in step 12 of the process (VCM start 674 in FIG. 18) uses BT or another short-range wireless protocol, together 524A, in DSCM 408 (FIG. 15) to push the welding task instructions and data to VCM 406 (FIG. 14) and gives the welding task start command to the VCM.

Step 13 of the process flies the vehicle to job 676 (FIG. 18) with DSCM 408 (FIGS. 12 and 15) disconnecting from VCM 406 (FIGS. 13A and 14) and welder vehicle 410 (FIG. 13A) leaves to execute the welding task. Then in step 14 of the process, the welder vehicle executes the welding task denoted as execute the weld 678 in FIG. 18. The flow chart of FIG. 12 illustrates one representative embodiment for the process of executing the weld in nineteen steps on its own.

Step 15 of the process is denoted as “complete and return” 680 in FIG. 18. When the welding task is fully executed or when monitoring software located in VCM 406 halts the execution process, Welder Vehicle 410 returns to the docking station for battery recharge and data transfer.

Step 16, denoted as “VCM data to DSCM, uses the previously established BT or other short-range wireless connectivity, 524A to 524, VCM 406 uploads the collected welding task data, sensor reading history, and recorded audio/video data to DSCM 408. (See FIGS. 14 and 15.) And in step 17 of the illustrative process (denoted DSCM data to cloud 684 in FIG. 18), DSCM 408 uploads the received welding task, sensor reading history, and audio/video data real-time to Welder Application Software 616 using previously established Wi-Fi/Broadband/Satellite connectivity 424A, e.g., through wireless antenna or umbilical connection 402 to remote server 426, also illustrated by cloud-based computer system 570. See FIGS. 13A and 15-17.

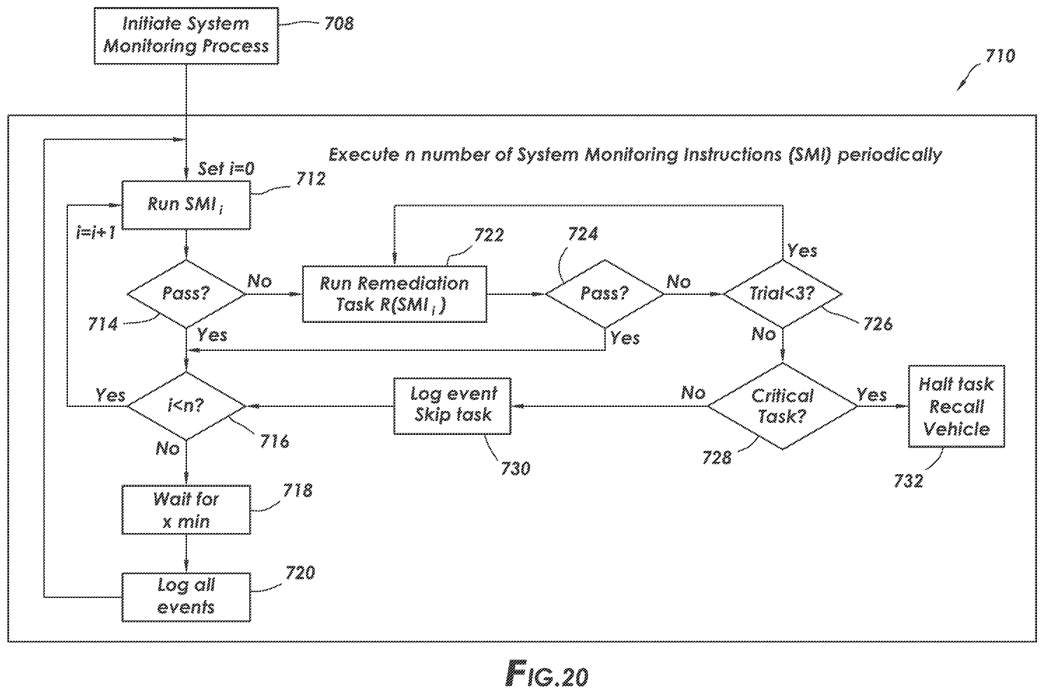

Step 18 of the process introduces instruction addition process 686. Based upon the received welding task data, Welder Application Software 616 generates new welding instructions to be used for training the welders for future tasks and sends the new welding instructions to systems engineers/analysts 622 for review and approval. See also FIG. 17. Upon approval by systems engineers/analysts those new rules are added to database located in Welder Process Instructions Engines 618A and 618 of internal and external production environments 610 and 612, respectively. An example of the welding instruction addition lifecycle is discussed hereinafter in greater detail with respect FIG. 19.

The flow chart of FIG. 18 concludes with operator quality control as Step 19 in the illustrative process. Operator 606 reviews the welding task execution data, received sensor reading history, as well as audio/video data and confirm successful completion of the task. If the task is not successfully completed, then the process restarts at process step 9, generating the welding task 668.

FIG. 19 is a flow diagram illustrating PFW system operator welding instruction addition lifecycle 700 for the process introduced as elemental step 686 in the process flow diagram of FIG. 18. Data developed by operators 606 within operator networks 608 can be uploaded to a private partition of external production system 612 accessible only to that operator network or can be downloaded to generate new welding instructions and register on welder application software for future use. Any new instructions generated are accessible to the contributing operators 606 only unless and until approved through this process.

The vetting process brings the new welding instructions before system engineers and analysts 622 and a decision branch 706 which may discard the instructions 704 or proceed with approval. The decision to discard may be based on, e.g., insufficient environmental data to evaluate proper context, independent risk assessment, or otherwise. If approved, the new welding instructions might be added to welder process instruction engine 618A for further research and developmental in internal production system 610 and/or welder process instruction engine 618 of external production system 612 and available throughout the community of users. Alternatively, system engineers and analysts 622 may first revise the proposed new welder process instruction engines before adding to the internal or external environments, as appropriate. Developments from internal production system 610 go through the same vetting process.

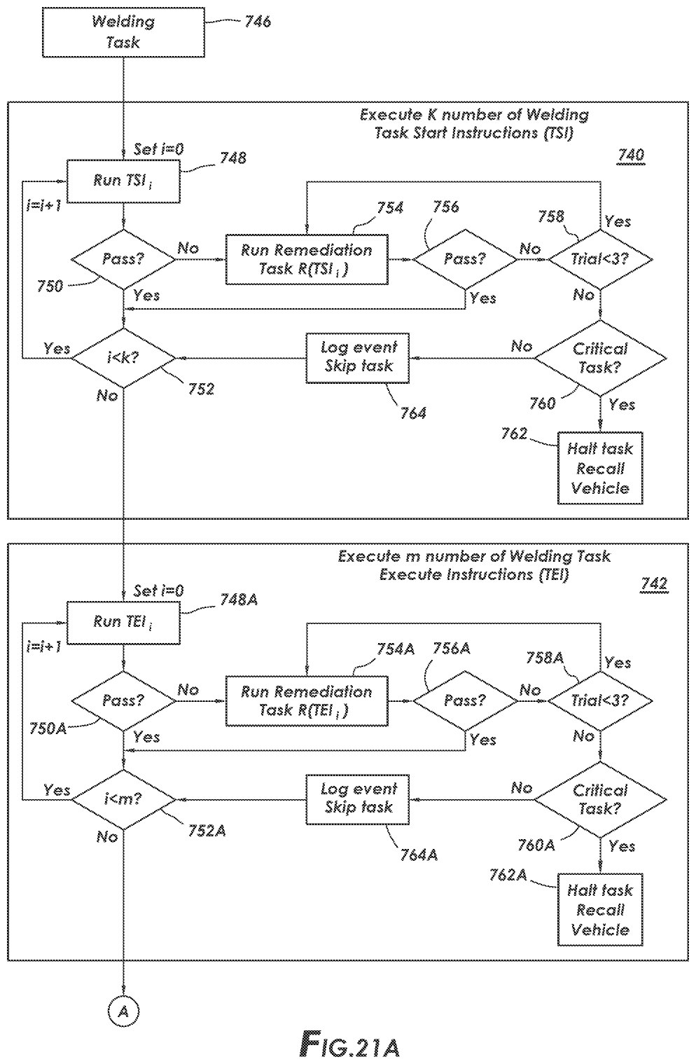

PFW Welding Process will generally execute five types of instruction sets and FIGS. 20 and 21 provide illustrative examples of software structures for several of these that might be deployed in implementing embodiments of the present invention.

One of these types of instruction sets are the System Monitoring Instructions or SMI which run iteratively and essentially continuously with a restart at a time interval determined by the System Analysts, preferably every minute. In order to protect the health of the equipment and prevent a damage, if any of the SMI fail to pass during monitoring, the VCM 406 halts the welding task and requests the vehicle 410 depart back to the docking station 408. See FIGS. 12 and 14.

Illustrative examples of System Monitoring Instructions comprise:
Vehicle_Battery_Level<10%
Read_Humidity_Sensor (Humidity Sensor #1)>10%
Read_Humidity_Sensor (Humidity Sensor #2)>10%

FIG. 20 illustrates a PFW system monitoring flow process 700 to do this which is initiated at step 708 to run an iterative system monitoring program SMIᵢ at step 712 with instructions show the health of the DSCM, VCM, welder, robotic arm, and their components. These can run in an order that is determined by the operator prior to, during, and after the execution of a welding task as well as while the vehicle is parked on docking station. If a particular instruction does not apply to the current task the instruction shall be skipped by the operator.

If the SMIᵢ review passes on a given run at decision 714 and the total iterations i do not exceed a maximum number n (decision 716), then 1 is added to the total number of iterations i and step 712 of running SMIᵢ is repeated. However, if the number of iterations i exceeds predetermined number n, the next rerun of SMIᵢ is delayed by x minutes, see step 718 for wait time and all events are logged (step 720) before returning to run another SMIᵢ iteration at step 712.

However, in the event that SMIᵢ run 712 fails the decision criteria of step 714, then a remediation task run 722 is run. If remediation is successful, decision 724 returns to the run the SMIᵢ do loop at decision 716. But if it fails, it is tried again at step 726, in this example tried up to three more times. If still failing, there is an inquiry 728 about whether it is a critical task. If not, the event is logged and the task is skipped, see step 730, the SMIᵢ do loop is repeated according to the run set out in step 716. But if it is critical, then vehicle 410 is retrieved to the docking station 408, refer also to FIG. 13A, if not to the surface for retrieval. In order to protect important components, system monitoring Instructions are generally, as a default, marked as “Critical”.

Regardless if vehicle 410 is parked at the docking station 408, traveling to job site, or actively executing welding task, all events are logged and system monitoring issues are reported to the operator 606 via welder application software 616 as soon as the VCM 406 is reconnected to DSCM 408 and the DSCM is reconnected to the welder application software. See step 732 in flow chart FIG. 20. See FIG. 13A and also FIGS. 14, 15 and 17.

Other instructions set within the PFW welding process are introduced in FIG. 21, including welding task start instructions (TSI) 740, welding task execute instructions (TEI) 742 and welding task inspection instructions (TII) 744. Each of these is discussed below along with remediation instructions (RI) which is not included in FIG. 21. In setting up the PFW welding process, each instruction types listed below will be identified and entered by the operator as “critical” or “noncritical” before the launch of a task.

A number k of task start Instructions (TSI) are initiated at step 746 in starting the welding task. These instructions, TSIᵢ 748 are run in an order determined by the operator immediately prior to the executing a welding task. If a particular instruction does not apply to the current welding task, that instruction is skipped by the operator.

One illustrative example of task start instructions comprises:
Read_Temperature_Sensor (Temperature Sensor #1)>x And Read_Temperature_Sensor (Temperature Sensor #2)>y
Image_Analyzer_Match_Percent (Target Image, Current Image)>90%
Read_Pressure_Sensor (Pressure Sensor #1)>x And Read_Pressure_Sensor (Pressure Sensor #1)<y
Read_Pressure_Sensor (Pressure Sensor #2)>z And Read_Pressure_Sensor (Pressure Sensor #2)<t
Read_Ultrasound_Sensor (Point 1)>x And Read_Ultrasound_Sensor (Point 2)>y And Read_Ultrasound_Sensor (Point 3)>z And Read_Ultrasound_Sensor (Point 4)>t
Self_test (Vehicle CM)=Pass
Self_test (Welder Robotic Arm)=Pass
Self_test (Welder)=Pass

As each task in TSIᵢ is run in set 748, there is a determination 750 as to whether approved conditions are met. If so, the next iteration is undertaken until all k tasks have been run. See step 752. Should any TSIᵢ fail, the appropriate remediation R(TSIᵢ) is run, step 754, retested in step 756 and returned to the TSIᵢ loop if it passes. If not, it is returned through R(TSIᵢ) 754 to try remediation again and retested in step 756 a predetermined number of times, e.g., up to three times, see step 758. If still unable to pass a trial TSIᵢ, the criticality of the task is considered as assigned before the initiation of welding activities, See step 760. If critical, the task is halted and the vehicle recalled, see step 762. If it is not critical, that event is logged and the task skipped in step 764.

Task Execution steps 742 can start only when all applicable Task Start Instructions 740 are successfully executed and passed or logged and passed over as non-critical. There are m task execution instructions (TEIᵢ) and these instructions are run (step 748A) in an order determined by the Operator during execution of a welding task. If a particular instruction does not apply to the current welding task, the instruction shall be skipped by the operator.

Illustrative examples of Task Execute Instructions (TEIᵢ) comprise:
Clean_Job_Area( )=Pass
Temporary_Fill_Leak( )=Pass

In this example, the logic and flow diagram of task execute instructions (TEI) 742 is the same for corresponding elements as that of welding task start instructions (TSI) 740, iterating through each of the tasks (running TEI 748A, testing 750A and counting iterations (step 752A), attempting remediation (step 754A), retesting (step 756A) and trying remediation again a predetermined number of times, e.g., up to three times (step 758A), then halting and recalling the vehicle (step 762A), if the task is critical (step 760A) or logging the event and skipping the task (step 764A) to return to the run TEI loop if not determined critical.

Similarly, there are a number n of Task Inspection Instructions (TIIᵢ) to be run in an order determined by the operator after execution of a welding task. If a particular instruction does not apply to the current welding task the instruction shall be skipped by the operator. Again, there is a flow and logic for the task inspection instructions (TIIᵢ) 744 that directly corresponds to that of the welding task start instructions (TSI) 740 and the welding task execute instructions (TEI) 742. Welding task inspection instructions (TII) iterate through each of the tasks (running TII 748B, testing 750B and counting iterations 752B), attempting remediation (754B), retesting (756B) and trying remediation again up to three times (758B), then halting and recalling the vehicle (762B) if the task is critical (760B) or logging the event and skipping the task (764B) to return to the run TEI loop if determined non-critical.

A welding task is considered successful only when all applicable task inspection Instructions (TIIi) are successfully executed and passed or logged and passed over as non-critical. All events are logged 766 and the task is complete, step 768.

Remediation Instructions (RI) are the other category of instructions introduced above generally and in reference to steps 754, 754A and 754B with reference to FIG. 21. These instructions are executed when a particular TSIᵢ, TEIᵢ, or TIIᵢ cannot be successfully completed. Specifically, the set of remediation instruction set will run in order to remediate a failed instruction. There may be one single RI or set of RIs to run in an order to mediate a particular failed TSIᵢ, TEIᵢ, or TIIᵢ. If remediation instructions cannot fix the situation and cannot cause the failed TSIᵢ, TEIᵢ, or TIIᵢ, or SMIᵢ to successfully pass and if the failed instruction was marked as “critical” then VCM 406 halts the welding task and requests the vehicle 410 depart back to the docking station 408.

An all-electric, portable friction welding system having automated control through multiple components being actively controlled to sensor monitored parameters during the welding process together with the instrumented monitoring of environmental conditions facilitates the collection of significant operational data. That data and the architecture and data handling discussed above facilitate the implementation of artificial intelligence through both supervised/un-supervised machine learning algorithms By acquiring real-time sensor data and by applying state-of-the-art machine learning algorithms, e.g., Viz. Random Forests, XG Boost, parameters can be modeled leading towards improved operations and a truly adaptive robotic portable friction welding system.

Illustrative parameter and modeling opportunities include, but are not limited to:
Temperature Control using Model Predictive Control
Mathematical Modelling of Welding Process to Predict the Joint Strength
Stress Evaluation during different Phases of Welding
Monitoring and control of Welding Process leading towards real-time quality inspection, predictive maintenance, and defect detection
Thermomechanical modelling and optimization of Welding process
3D modelling of material flow of Friction Welding
Process modelling and diagnostic considerations towards advanced diagnostics
Power consumption, particularly in battery powered implementations

Deep reinforcement learning approaches are also facilitated. For instance, the range of current AUVs is limited by the on-board energy storage capacity. To achieve persistent systems, AUVs will need to autonomously dock onto charging stations. The docking maneuver of an AUV contains two stages i.e., homing and final docking. The homing phase consists of AUV approaching the docking station, whereas final docking describes the actual connection process once the AUV enters the funnel. Reinforcement Learning is a decision-making framework in which an agent learns a desired behavior or policy from direct interactions with the environment. At each time step, the agent is in a state and takes and action. As a result, it lands in a new state while receiving a reward. A Markov decision process can be used to model the action selection depending on the value function which represents an estimate of the future reward. By interacting the environment for a long time, the agent learns an optimal policy, which maximizes the total expected reward. Reinforcement Learning based controllers are highly anticipated for their capability to enable adaptive autonomy in an optimal manner. Reinforcement Learning looks ahead to future events and focuses on long term performance, making it appealing to control problems.

Underwater vehicle hydrodynamics are highly non-linear with uncertainties that are difficult to parameterize and in addition unknown disturbances are usually present as are typical of aquatic environments. Due to the uncertainty of underwater dynamics, we mainly focus on model-free class of Reinforcement Learning algorythems. High maneuverability is especially desirable in situations where there are strong disturbances, i.e., due to ocean currents, or where the AUV is attempting to dock onto a moving platform, i.e., for example for retrieval from a floating vessel. The most common underwater vehicle configurations have four, five and even six engines. This implies that the low-level control system must simultaneously manipulate the continuous output of up to six thrusters to achieve the stated dynamic references, i.e., the set-points for the linear and angular velocities. Thus, the control system can deal with a non-linear continuous problem in six degrees of freedom in an uncertain and variable environment. Implementing such reinforcement algorithm in real-time allowing the data to be slowly replaced with the data coming from the actual vehicle and the neural networks can be retrained off-line. Hence, a reinforcement learning (RL) approach can optimize control at a much lower computational cost at deployment. In addition, its model-free nature provides a general framework that can be easily adapted to the control of different systems, although it is necessary to tune the parameters for the task at hand for best results.

Most of the existing applications of deep RL use video images to train the decision-making artificial agent but obtaining camera images only for an AUV control purpose could be costly in terms of energy consumption. Moreover, the rewards are not easily obtained directly from the video frames. By contrast, a deep reinforcement learning framework for adaptive control applications of AUVs based on an actor-critic goal-oriented deep RL architecture takes the available raw sensory information as input and outputs the continuous control actions as low-level commands for, e.g., the AUV's thrusters. Most of the deep learning control proposals have used image pixels to learn a control policy to solve complex control tasks and often have been tested using only simulation platforms. In contrast, an adaptive controller for low-level control of host vehicles, e.g., underwater mobile robots, using only the navigation measurements.

Again, the illustrative examples discussed above are by way of example only. Those skilled in the art, given the benefit of this disclosure, may adapt electric portable friction welding to other marine applications, terrestrial robotic applications, drone applications and even applications in space, benefitting each of autonomous. remotely controlled, and manned operation, without departing from the scope of the present invention.

What is claimed is:

1. An automated friction welding system for friction welding a fixture onto a substrate at an interface between the fixture and the substrate using an electric power system, said system comprising:
a friction welding tool operably connectable to the power system, said friction welding tool comprising:
a tool housing;
a linear actuator received in an axially slidable relation to produce a defined stroke within the tool housing;
a rotary motor disposed in the tool housing and engaged to said linear actuator to slide therewith;
a collet configured to receive the fixture;
a control system, comprising:
one or more motor operation sensor(s) and one or more linear actuator operation sensor(s), each capable of producing an operations sensor output;
a control module, comprising:
a central processing unit;
read only memory;
a set of firmware instruction installed on the read only memory;
read access memory that can receive job instructions;
a sensor controller connected to receive the operations sensor output from the linear actuator operation sensor(s) and the motor operation sensor(s);
a welder controller with outputs connected to the linear actuator and the rotary motor;
whereby the control module affords both active control of the linear actuator and rotary motor, individually to performance parameter instructions, and in coordination through phases of the weld process in response to the operations sensor output from linear actuator operation sensors and motor operation sensors.

2. An automated friction welding system in accordance with claim 1 for forming a weld at a selected weld location, wherein:
the one or more motor operation sensor(s) are selected from a group comprising rpm, torque, heat, humidity and power consumption; and
the one or more linear actuator operation sensor(s) are selected from a group comprising forging force, length of stroke, velocity of stroke, heat, humidity, and power consumption.

3. An automated friction welding system in accordance with claim 2, wherein the control system comprises:
one or more environmental sensors selected from the group comprising ultrasonic transducers, cameras, proximity sensors, temperature sensors, depth sensors and metallurgical identification, the environmental sensors being in communication with the control module and capable of producing an environmental sensor output; and
an input/output provision through which any additional data necessary to identify appropriate job instructions to be loaded into the control module;
whereby the environmental conditions at the weld location are identified for controlling the weld operations and completed weld may be inspected and evaluated at the time of the weld.

4. An automated friction welding system in accordance with claim 3, wherein the control system further comprises:
a remote server system; and
a library of possible job instructions stored on the server.

5. An automated friction welding system in accordance with claim 4, wherein the remote server system is cloud based.

6. An automated friction welding system in accordance with claim 5, wherein the remote server system further comprises:
an external production system connectable for communication with the control module for both uploads and downloads, comprising:
welder device APIs through which the external production system can communicate with the portable friction welding tool;
external welder application software;
external welder process instructions engine; and
external security API protecting the external production system;
an internal production system, comprising:
internal production system welder application software;
internal production system welder process instructions engine;
internal production system security API; and
provisions for a vetting process through which data uploaded from the control module of the friction welder to the external production system is qualified and uploaded to the internal production system and through which internal production system welder application software and internal production system welder process instructions engines are qualified and downloaded to the external production system for accessibility to the control module of the portable friction welding tool.

7. An automated friction welding system in accordance with claim 6, wherein modification of existing instructions and generation of new instructions by the VCM itself under supervised and reinforced learning rules.

8. An automated friction welding system in accordance with claim 7, wherein the host vehicle and the friction welding tool are autonomous robots, further comprising AI tools in the control module supporting autonomous operation whereby breaking with a defined pattern is recognized as an anomaly and the portable friction welding tool shuts down without human intervention.

9. An automated friction welding system in accordance with claim 7, wherein the control module further comprises adaptive AI based upon reinforcement learning techniques to facilitate rapid development of enhanced instructions.

10. An automated friction welding system in accordance with claim 10, the reinforced learning directed to optimizing the strength of the weld based on weld inspection criteria.

11. An automated friction welding system in accordance with claim 10, wherein the instructions further comprise a weld strength requirement and wherein the reinforced learning is directed to minimize power consumption while the maintaining weld strength requirements based on weld inspection criteria.

12. An automated friction welding system in accordance with claim 7, wherein the control module further comprises AI to identify anomalies or other conditions, determines the likelihood it is critical, makes a recommendation and communicates this to a human supervisory operator.

13. A modular automated friction welding system mountable in a host vehicle system for friction welding a fixture onto a substrate at an interface between the fixture and the substrate using an electric power system, said portable friction welding system comprising:
a portable friction welding tool operably connectable to the power system, said portable friction welding tool comprising:
a tool housing;
a linear actuator received in an axially slidable relation to produce a defined stroke within the tool housing;
a rotary motor disposed in the tool housing and engaged to said linear actuator to slide therewith;
a collet configured to receive the fixture;
a control system, comprising:
one or more motor operation sensor(s);
one or more linear actuator operation sensor(s);
a control vehicle PFW module, comprising:
a central processing unit;
read only memory;
a set of firmware instruction installed on the read only memory;
read access memory that can receive job instructions;
a sensor controller connected to receive input from the linear actuator operation sensor(s) and the motor operation sensor(s);
a welder controller with outputs connected to the linear actuator and the rotary motor;
whereby the vehicle PFW control module affords both active control of the linear actuator and rotary motor, individually to performance parameter instructions, and in coordination through phases of the weld process in response to linear actuator operation sensors and motor operation sensors;
an intermediary relay station engagable for communication with the vehicle PFW control module; and
a remote server engable for communication with the intermediary relay station.

14. A modular automated portable friction welding system in accordance with claim 13, wherein the host vehicle is a AUV and the intermediary relay station is mounted in a docking station locatable in the vicinity of a job.

15. A modular automated portable friction welding system in accordance with claim 14 wherein the host vehicle is an ROV and the intermediary relay station is mounted in a docking station locatable in the vicinity of a job.

16. A portable friction welding network for a fleet of portable friction welding tools, said network comprising:
a plurality of operator networks, each operator network employing one or more portable friction welding tools within the fleet;
an external production system on a remote server, the external production system comprising:
a suite of external production system welder application software;
a welder device API through which the external production system is connectable to the fleet of portable friction welding tools for loading the welder application software of general-purpose instructions onto the fleet;
an external production system welder process instructions engine which serves as a library of friction job specific welding recipes;
an external production system security API through which each of the operator networks can download an applicable welding recipe for a specific job.

17. A portable friction welding network in accordance with claim 16, further comprising:
a partition of memory in the external production system loaded on the remote server whereby each operator network uploads the job experience of that operator network for its private reference and it is not available to other operator networks unless it is vetted to be incorporated in generally available external production system.

18. A portable friction welding network in accordance with claim 17, further comprising:
an internal production system comprising:
a suite of internal production system welder application software;
an internal production welder process instructions engine which serves as a library of friction job specific welding recipes; and
an internal production system security API; and
a vetting process managing access between the Internal production system and the external production system;
whereby data received in the external production system from the operator networks work experience is analyzed for consideration for entrance into the internal production system and modifications to the internal production system welder application software and weld recipes are developed and vetted in the internal production system and, if of general interest, released to the external production system for distribution to the fleet and operator networks.

19. A method for supporting portable friction welding operations, comprising:
engaging a fleet of portable friction welding tools;
establishing a plurality of operator networks;
creating an external production system on a remote server, the external production system having an external production system welder device API, an external production system suite of welder application software, an external production system welder process instructions engine containing a library of job specific welding recipes; and an external production system security API;
creating an internal production system on the remote server, the internal production system having an internal production system suite of welder application software, an internal production system welder process instructions engine containing a library of job specific welding recipes; and
an internal production system security API;
establishing an vetting process connecting the external production system and the internal production system;
downloading the external production system welder application software onto the fleet of portable friction welding tools;
downloading onto the portable friction welding tool of the operator network a job specific weld recipe of weld parameters suitable of conditions that are thought to characterize a given job from a library in the external production system welder process instructions engine;
periodically uploading data from job histories to the external production system; and
analyzing the data for broader applicability in a vetting process and communicating the data with potential to the internal production system, evaluating developments within the internal production software for effectiveness and applicability and bringing desired developments into the external production system where it will be available to operator networks and to the fleet of portable friction welders.

20. A method for supporting portable friction welding operations in accordance with claim 19, further comprising modifying existing instructions and generating new instructions by the VCM itself under supervised and reinforced learning rules.

21. A method for supporting portable friction welding operations in accordance with claim 19, wherein the host vehicle and the portable friction welding tool are autonomous robots and further comprising supporting autonomous operation with AI based tools whereby breaking with a defined pattern is recognized as an anomaly and the portable friction welding tool shuts down without human intervention.

22. A method for supporting portable friction welding operations in accordance with claim 19, further comprising applying adaptive AI based upon reinforcement learning techniques to facilitate rapid development to enhance the job specific welding recipes.

23. A method for supporting portable friction welding operations in accordance with claim 22, wherein applying the reinforced learning techniques are directed to optimizing weld strength based on weld inspection criteria.

24. A method for supporting portable friction welding operations in accordance with claim 23, wherein applying the reinforced learning techniques is directed to minimize power consumption while maintaining weld strength requirements based on weld inspection criteria.

25. An automated portable friction welding system for mounting on a host vehicle and supported by a docking station and a remote server, said portable friction welding system operable to friction weld a fixture onto a substrate at an interface between the fixture and the substrate using an electric power system, said system comprising:
a portable friction welding tool mounted on the host vehicle, said portable friction welding tool comprising:
a tool housing;
a linear actuator received in an axially slidable relation to produce a defined stroke within the tool housing;
a rotary motor disposed in the tool housing and engaged to said linear actuator to slide therewith;
a collet configured to receive the fixture;
a control system, comprising:
one or more motor operation sensor(s);
one or more linear actuator operation sensor(s);
a vehicle control module carried on the host vehicle, comprising:
a VCM communication provision electrically connected to the main bus;
a central processing electrically connected to the main bus unit;
read only memory electrically connected to the main bus;
a set of VCM firmware instruction installed on the read only memory;
a VCM power management system electrically connected to the VCM main bus and electrically connectable to the vehicle power provisions;
a sensor controller connected to receive input from the linear actuator operation sensor(s) and the motor operation sensor(s);
a welder controller with outputs connected to the linear actuator and the rotary motor;
a docking station PFW control module, comprising;
a DSCM main bus;
a first DSCM communication provision electrically connected to the main bus and operably connectable to the VCM communication provision to upload job instructions to the VCM download data from the VCM communication provision when the host vehicle is docked at the docking station;
a second DSCM communication provision electrically connected to the main bus and operably connectable to upload data to and download job instructions from the remote server;
a DSCM storage device electrically connected to the main bus;
a DSCM central processing unit electrically connected to the bus;
a DSCM read only memory electrically connect to the main bus;
a DSCM power management system electrically connected to the main bus and to the docking station vehicle power provisions; and
a set of DSCM firmware instructions installed on the DSCM read only memory;
whereby the control module affords both active control of the linear actuator and rotary motor, individually and in coordination, using sensor input to manage performance parameters downloadable from remote server, through the first and second DSCM communication provisions and the VCM communication provisions to the VCM read access memory and whereby data from operations is uploadable to the remote server through the first and second DSCM communication provisions and the VCM communication provisions.

26. An automated portable friction welding system in accordance with claim 25, wherein modification of existing instructions and generation of new instructions by the VCM itself under supervised and reinforced learning rules.

27. An automated portable friction welding system in accordance with claim 26, wherein the host vehicle and the portable friction welding tool are autonomous robots, further comprising AI tools in the control module supporting autonomous operation whereby breaking with a defined pattern is recognized as an anomaly and the portable friction welding tool shuts down without human intervention.

28. An automated portable friction welding system in accordance with claim 26, wherein the control module further comprises adaptive AI based upon reinforcement learning techniques to facilitate rapid development and enhancement of job specific welding recipes.

29. An automated portable friction welding system in accordance with claim 27, wherein the reinforced learning directed to optimizing weld strength based on weld inspection criteria.

30. An automated portable friction welding system in accordance with claim 27, wherein the reinforced learning is directed to minimize power consumption while maintaining weld strength requirements based on weld inspection criteria.

31. An automated portable friction welding system in accordance with claim 26, wherein the control module further comprises AI to identify anomalies or other conditions, determines the likelihood it is critical, makes a recommendation and communicates this to a human supervisory operator.

32. A method for friction stud welding in the field, said method comprising:
deploying a friction welding tool having a control module, a rotary motor, a forging force actuator and an array of operational sensors monitoring a predetermined set of variables regarding the operation of the motor and the forging force actuator;
matching a weld plan defined by operational values in the predetermined set of variables to a combination of stud size, stud material, substrate material, and environmental conditions and uploading weld plan to the control module;
conducting a friction stud welding cycle moderated through the control module using the weld plan and feedback from the array of operational sensors.

33. A method for friction stud welding in the field in accordance with claim 32, wherein the predetermined variables are selected from a group comprising rpm, torque, heat, humidity, power consumption, forging force, length of stroke, velocity of stroke, and time.

34. A method for friction stud welding in the field in accordance with claim 32, wherein the control module coordinates and independently manages the operation of the motor and the forging force actuator.

35. A method for friction stud welding in the field in accordance with claim 34, wherein
matching a weld plan further comprises defining characteristics for an optimized weld;
conducting the friction stud welding cycle further moderated with AI pursuing the optimized weld.
